(19) United States
(12) Patent Application Publication
(10) Pub. No.: US 2026/0343020 A1
(43) Pub. Date: Oct. 29, 2026

(54) METHOD AND DEVICE FOR VIDEO CODING USING IMPROVED CROSS-COMPONENT LINEAR MODEL PREDICTION

(71) Applicants: HYUNDAI MOTOR COMPANY, Seoul (KR); KIA CORPORATION, Seoul (KR); Research & Business Foundation SUNGKYUNKWAN UNIVERSITY, Suwon-si (KR)

(72) Inventors: Byeung Woo Jeon, Seongnam-si (KR); Jee Hwan Lee, Gwacheon-si (KR); Bum Yoon Kim, Yongin-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); Research & Business Foundation SUNGKYUNKWAN UNIVERSITY, Suwon-si (KR)

(21) Appl. No.: 19/115,123

(22) PCT Filed: Dec. 6, 2022
(86) PCT No.: PCT/KR2022/019676

§ 371 Date: Mar. 25, 2025

(30) Foreign Application Priority Data
Sep. 26, 2022 (KR) 10-2022-0121555
Dec. 5, 2022 (KR) 10-2022-0167522

(51) Int. Cl. H04N 19/593; H04N 19/105; H04N 19/11; H04N 19/119; H04N 19/14; H04N 19/176; H04N 19/186

(52) U.S. Cl. CPC H04N 19/593; H04N 19/105; H04N 19/11; H04N 19/119; H04N 19/14; H04N 19/176; H04N 19/186

(57) ABSTRACT

A method and an apparatus are disclosed for video coding using an improved cross-component linear model prediction. In the disclosed embodiments, a video coding method and an apparatus generate the first predictor of the current chroma block by the CCLM prediction, and further generate the second predictor of the current chroma block based on the reconstructed neighbor pixels. The video coding method and the apparatus weight-sum the first predictor and the second predictor when the current chroma block is intra-predicted.

### CROSS-REFERENCE TO RELATED APPLICATIONS

This application is a U.S. national stage of International Application No. PCT/KR2022/019676, filed on Dec. 6, 2022, which claims priority to and the benefit of Korean Patent Application No. 10-2022-0121555, filed on Sep. 26, 2022, and Korean Patent Application No. 10-2022-0167522, filed on Dec. 5, 2022, the entire contents of each of which are incorporated herein by reference.

### TECHNICAL FIELD

The present disclosure relates to a video coding method and an apparatus using an improved cross-component linear model prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In general, the image to be encoded is partitioned into coding units (CUs) of various shapes and sizes and then encoded by the units of CU. A tree structure represents information that prescribes the CU-by-CU partitioning, and the tree structure may be transferred from the encoder to the decoder to indicate how the image is partitioned. When the CU-by-CU partitioning is performed, the luma and chroma images may be partitioned independently. Alternatively, the luma signal and the chroma signal may be partitioned into the same structure of CUs. In this case, the technique for providing the luma signal and chroma signal with different partition structures is called the Chroma Separate Tree (CST) technique or dual tree technique. When CST technology is used, the chroma block may have a different partitioning method than the luma block. Additionally, a technique for providing the luma and chroma signals with the same partition structure is called a single tree technique. When the single tree technique is used, the chroma block has the same partitioning method as the luma block.

Meanwhile, there is a linear relationship between the pixels of the chroma signal and the corresponding pixels of the luma signal. Accordingly, cross-component linear model prediction (CCLM prediction) exists as a prior art technique that can use this linear relationship to generate an intra predictor of the chroma signal from the pixels of the luma signal. To make an intra prediction of the current chroma block, the CCLM prediction first determines a corresponding luma region within the luma image, which corresponds to the current chroma block. The CCLM prediction then derives a linear model between the pixels on the neighboring pixel lines of the current chroma block and the corresponding luma pixels. Finally, the CCLM prediction uses the derived linear model to generate a predictor of the current chroma block from the pixel values in the corresponding luma region.

CCLM prediction has an issue that, as described above, CCLM prediction uses neighboring pixels of the current chroma block for the derivation of the linear model, but CCLM prediction does make no use of the reconstructed neighbor pixels to generate the predictor. Therefore, to enhance video quality and increase coding efficiency during the intra prediction of the current chroma block, there is a need to take into account a method of further taking advantage of reconstructed neighbor pixels when the CCLM prediction is used.

### SUMMARY

The present disclosure seeks to provide a video coding method and an apparatus that generate a first predictor of a current chroma block by the CCLM prediction, and further generate a second predictor of the current chroma block based on reconstructed neighbor pixels. The video coding method and the apparatus weight-sum the first predictor and the second predictor to improve the prediction performance of the cross-component linear model prediction (CCLM prediction) in intra-predicting the current chroma block

At least one aspect of the present disclosure provides a method of intra predicting a current chroma block by a video decoding device. The method includes decoding a cross-component prediction mode for making a cross-component prediction for the current chroma block. The cross-component prediction predicts the current chroma block by using pixels of a corresponding luma region with respect to the current chroma block and the corresponding luma region. The method also includes generating a first predictor of the current chroma block by performing the cross-component prediction based on the cross-component prediction mode. The method also includes inferring a representative mode from reconstructed information on a neighboring chroma pixel region that comprises pixels neighboring the current chroma block The reconstructed information contains values of pixels in the neighboring chroma pixel region, positions of the pixels, and a number of the pixels. The method also includes generating a second predictor of the current chroma block by performing an intra prediction that uses neighboring pixels of the current chroma block based on the representative mode. The method also includes deriving weights for the first predictor and the second predictor. The method also includes generating an intra predictor of the current chroma block by weight summing the first predictor and the second predictor by using the weights.

Another aspect of the present disclosure provides a method of intra predicting a current chroma block by a video encoding device. The method includes determining a cross-component prediction mode for making a cross-component prediction for the current chroma block. The cross-component prediction predicts the current chroma block by using pixels of a corresponding luma region with respect to the current chroma block and the corresponding luma region. The method also includes generating a first predictor of the current chroma block by performing the cross-component prediction based on the cross-component prediction mode. The method also includes inferring a representative mode from reconstructed information on a neighboring chroma pixel region that comprises pixels neighboring the current chroma block. The reconstructed information contains values of pixels in the neighboring chroma pixel region, positions of the pixels, and a number of the pixels. The method also includes generating a second predictor of the current chroma block by performing an intra prediction that uses neighboring pixels of the current chroma block based on the representative mode. The method also includes deriving weights for the first predictor and the second predictor. The method also includes generating an intra predictor of the current chroma block by weight summing the first predictor and the second predictor by using the weights.

Yet another aspect of the present disclosure provides a computer-readable recording medium storing a bitstream generated by a video encoding method. The video encoding method includes determining a cross-component prediction mode for making a cross-component prediction for a current chroma block. The cross-component predicts predicting the current chroma block by using pixels of a corresponding luma region for the current chroma block and the corresponding luma region. The video encoding method also includes generating a first predictor of the current chroma block by performing the cross-component prediction based on the cross-component prediction mode. The video encoding method also includes inferring a representative mode from reconstructed information on a neighboring chroma pixel region that comprises pixels neighboring the current chroma block. The reconstructed information contains values of pixels in the neighboring chroma pixel region, positions of the pixels, and a number of the pixels. The video encoding method also includes generating a second predictor of the current chroma block by performing an intra prediction that uses neighboring pixels of the current chroma block based on the representative mode. The video encoding method also includes deriving weights for the first predictor and the second predictor. The video encoding method also includes generating an intra predictor of the current chroma block by weight summing the first predictor and the second predictor by using the weights.

As described above, the present disclosure provides a video coding method and an apparatus that generate the first predictor of the current chroma block by the CCLM prediction, and further generate the second predictor of the current chroma block based on the reconstructed neighbor pixels. The video coding method and the apparatus weight-sum the first predictor and the second predictor when the current chroma block is intra-predicted. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the neighboring pixels referenced for cross-component linear model (CCLM) prediction.

FIG. 7 is a diagram illustrating information available to a chroma channel in intra prediction.

FIG. 8 is a diagram illustrating an intra predictor performing intra prediction of a chroma block, according to at least one embodiment of the present disclosure.

FIG. 9 is a diagram illustrating a neighboring chroma pixel region, according to at least one embodiment of the present disclosure.

FIGS. 10 and 11 are diagrams illustrating intensity histograms for each directional mode, according to at least one embodiment of the present disclosure.

FIG. 12 is a diagram illustrating a neighboring chroma pixel region, according to another embodiment of the present disclosure.

FIGS. 13A and 13B are diagrams illustrating intensity histograms by directional mode, according to other embodiments of the present disclosure.

FIG. 14 is a diagram illustrating a neighboring chroma pixel region, according to yet another embodiment of the present disclosure.

FIG. 15 is a diagram illustrating a distortion histogram for each directional mode, according to at least one embodiment of the present disclosure.

FIGS. 16A and 16B are flowcharts of an intra-prediction method for the current chroma block, according to at least one embodiment of the present disclosure.

FIG. 17 is a diagram illustrating a luma pixel region within a corresponding luma region, according to at least one embodiment of the present disclosure.

FIG. 18 is a diagram illustrating a luma pixel region, according to another embodiment of the present disclosure.

FIGS. 19 through 21 are diagrams illustrating distributions of neighboring blocks and prediction modes of a current chroma block, according to other embodiments of the present disclosure.

FIGS. 22 and 23 are diagrams illustrating distributions of blocks and prediction modes in a corresponding luma region, according to other embodiments of the present disclosure.

FIG. 24 is a diagram illustrating an intensity histogram for each directional mode, according to yet another embodiment of the present disclosure.

FIG. 25 is a diagram illustrating distributions of neighboring blocks and prediction modes of the current chroma block, according to yet another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

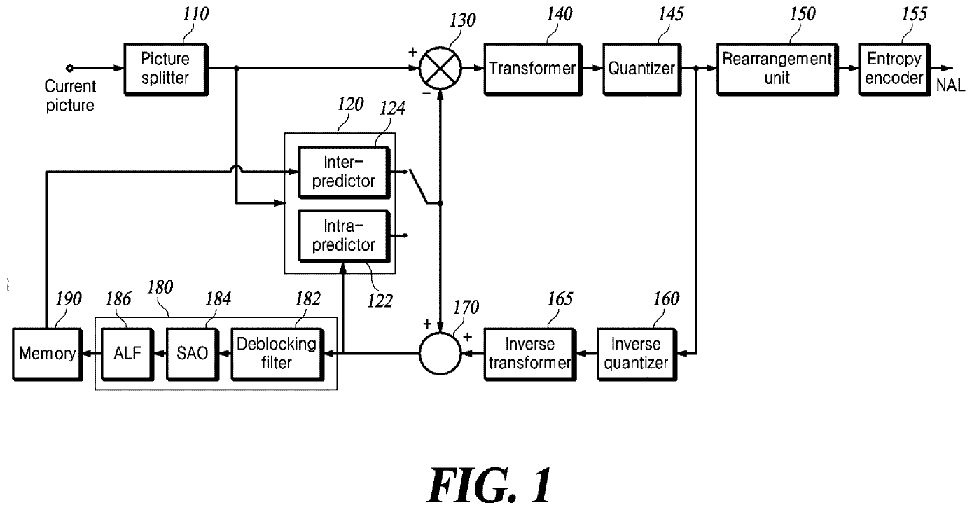

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

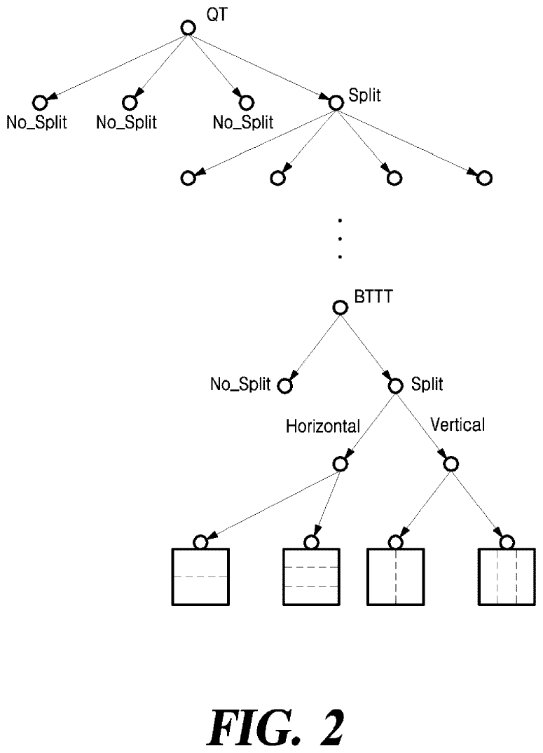

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape. The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

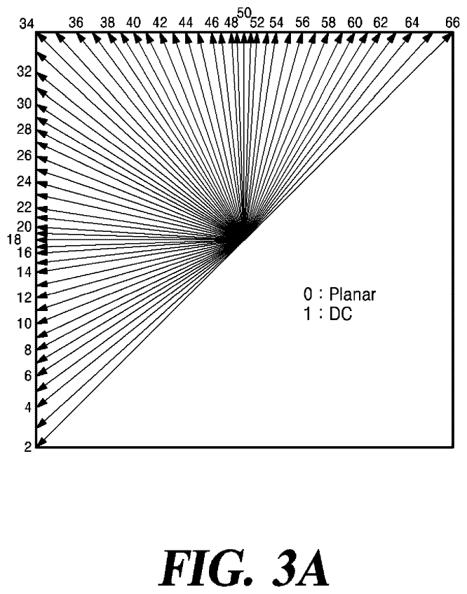

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

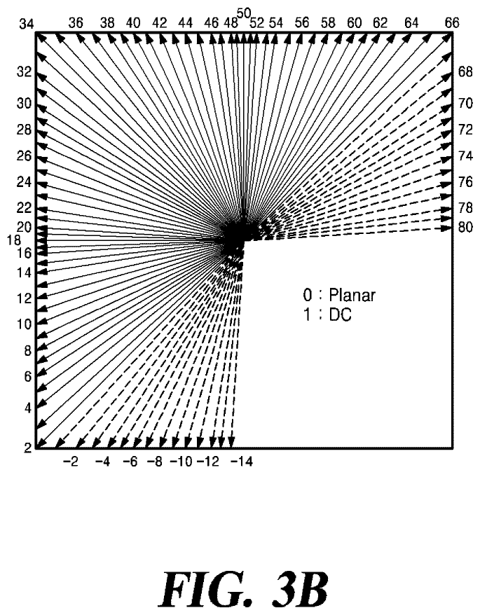

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

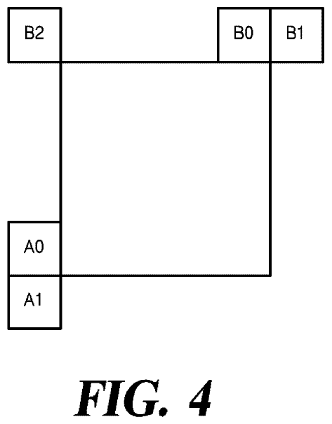

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that generate a first predictor of the current chroma block by the CCLM prediction, and further generate a second predictor of the current chroma block based on reconstructed neighbor pixels. The video coding method and the apparatus weight-sum the first predictor and the second predictor when the current chroma block is intra-predicted.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Hereinafter, a target block includes a luma block including a luma component, and a chroma block including a chroma component. The chroma block of the target block is represented by the target chroma block or the current chroma block. The luma block of the target block is represented by the target luma block or the current luma block.

Further, the aspect ratio of the block is defined as the length of the horizontal side of the block divided by the length of the vertical side of the block.

### I. Cross-Component Linear Model (CCLM) Prediction

In the VVC (Versatile Video Coding) technique, the intra-prediction mode of the luma block has subdivided directional modes (i.e., 2 to 66), in addition to non-directional (i.e., planar and DC) modes, as illustrated in FIG. 3A. Furthermore, as added by the example in FIG. 3B, the intra-prediction mode of the luma block has directional modes (−14 to −1 and 67 to 80) based on the wide-angle intra-prediction.

Depending on the prediction direction utilized by the luma block, the chroma block may also have limited access to the intra prediction of these subdivided directional modes. However, the intra prediction of the chroma block may not always utilize the various directional modes available to the luma block besides the horizontal and vertical directions. To be able to use these different directional modes, the prediction mode of the current chroma block needs to be set to derived mode (DM). By this setting to DM, the current chroma block may utilize directional modes other than the horizontal and vertical modes of the luma block.

When a chroma block is encoded, the intra-prediction modes that are used frequently or are the most basic to maintain video quality include planar, DC, vertical, horizontal prediction modes, and DM. In DM, the intra-prediction mode of the luma block that spatially corresponds to the current chroma block is utilized as the intra-prediction mode of the chroma block.

The video encoding device may signal to the video decoding device whether the intra-prediction mode of the chroma block is DM. The video encoding device may communicate DM to the video decoding device in a number of ways. For example, the video encoding device may indicate whether the intra-prediction mode of the chroma block is DM by setting the intra_chroma_pred_mode, which is information for indicating the intra-prediction mode of the chroma block, to a specific value and transmitting the information to the video decoding device.

If the chroma block is encoded in intra-prediction mode, the intra-predictor 542 of the video decoding device may set the intra-prediction mode, IntraPredModeC of the chroma block according to Table 1.

Hereinafter, to distinguish intra_chroma_pred_mode, the information related to the intra-prediction mode of the chroma block from IntraPredModeC, they are denoted as chroma intra-prediction mode predictor and chroma intra-prediction mode, respectively.

TABLE 1

| cclm_{—} | cclm_{—} | intra_{—} | lumaIntraPredMode | | | | |
|---|---|---|---|---|---|---|---|
| mode_{—} | mode_{—} | chroma_{—} | | | | | X (0 <= |
| flag | idx | pred_mode | 0 | 50 | 18 | 1 | X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

Here, lumaIntraPredMode is the intra-prediction mode of the luma block corresponding to the current chroma block (hereinafter, the ‘luma intra-prediction mode’). The lumaIntraPredMode represents one of the prediction modes illustrated in FIG. 3A. For example, in Table 1, the equation that lumaIntraPredMode=0 refers to the planar prediction mode, and the equation that lumaIntraPredMode=1 refers to the DC prediction mode. lumaIntraPredMode of 18, 50, and 66 indicate directional modes, referred to as horizontal, vertical, and VDIA, respectively. On the other hand, equations that intra_chroma_pred_mode=0, 1, 2, and 3 indicate the planar, vertical, horizontal, and DC prediction modes, respectively. The equation that intra_chroma_pred_mode=4 is DM. The value of IntraPredModeC, which is the chroma intra-prediction mode, is set equal to the value of lumaIntraPredMode.

Hereinafter, embodiments are described centering on parsing of encoding information by the video decoding device. However, for ease of description, reference is made to the video encoding device when necessary. Nevertheless, most of the embodiments described herein may be equally or similarly applied to the video encoding device. The video encoding device determines encoding information in terms of optimizing rate distortion. The video encoding device then encodes the encoding information to generate and signal the bitstream to the video decoding device. Further, the video encoding device may obtain the encoding information from a higher level to proceed with a subsequent encoding process.

In performing prediction in video encoding/decoding devices, there is a cross-component prediction defined by a method of generating a prediction block of a current block to be encoded and decoded from a color component that is different from the current block's color component. In the VVC technique, the cross-component prediction is performed by using the linear relationship between the chroma pixels and the corresponding luma pixels to intra predict the current chroma block, which is called cross-component linear model prediction (CCLM prediction). The following describes the CCLM prediction.

First, the process of parsing the intra-prediction mode of the current chroma block, performed by the video decoding device, is shown in Table 2.

TABLE 2

```
if( CclmEnabled )
  cclm_mode_flag
if( cclm_mode_flag )
  cclm_mode_idx
else
  intra_chroma_pred_mode
```

The video decoding device parses cclm_mode_flag to indicate whether CCLM prediction mode is enabled or disabled. If cclm_mode_flag is 1, indicating the use of CCLM mode, the video decoding device parses cclm_mode_idx to parse the index of CCLM mode. At this time, depending on the value of cclm_mode_idx, the CCLM mode may indicate one of three modes. On the other hand, if the cclm_mode_flag is 0, indicating no use of CCLM mode, the video decoding device parses the intra_chroma_pred_mode which indicates the intra-prediction mode, as described above.

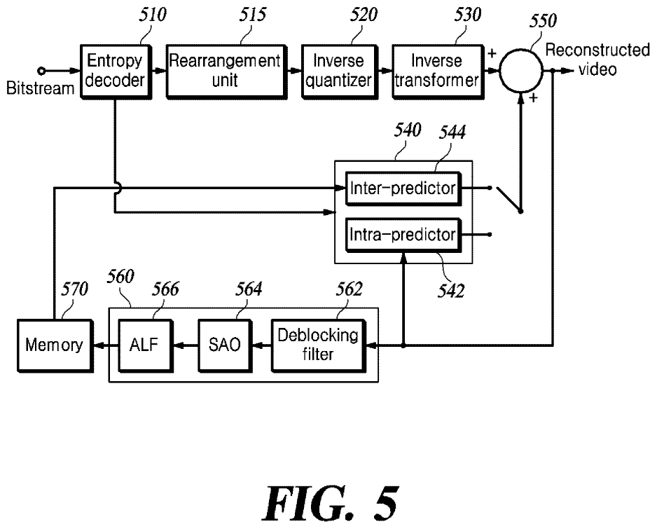

FIG. 6 is a diagram illustrating the neighboring pixels referenced for CCLM prediction.

If the CCLM mode is applied for the intra prediction of the current chroma block, the video decoding device determines a region in the luma image corresponding to the current chroma block, which is referred to as the ‘corresponding luma region’ hereinafter. Utilized for prediction of the linear model may be the left reference pixels and the top reference pixels of the corresponding luma region, and the left reference pixels and the top reference pixels of the target chroma block. Hereinafter, the left reference pixels and the top reference pixels are commonly expressed as reference pixels, neighboring pixels, or adjacent pixels. Further, reference pixels of the chroma component are denoted as chroma reference pixels, and reference pixels of the luma component are denoted as luma reference pixels. In the example of FIG. 6, the size of the chroma block, i.e., the number of pixels, is represented by N×N where N is a natural number.

CCLM prediction generates a prediction block that is a predictor of the target chroma block by deriving a linear model between reference pixels of the luma region and reference pixels of the chroma block and then applying the linear model to reconstructed pixels in the corresponding luma region. For example, as illustrated in FIG. 6, used for the derivation of the linear model may be four pairs of pixels obtained by combining pixels on a neighboring pixel line of the current chroma block with pixels in the corresponding luma region. The video decoding device may derive α and β representing the linear model as shown in Equation 1 for the four pairs of pixels.

$$α = \frac{{Y}_{b} - {Y}_{a}}{{X}_{b} - {X}_{a}} , \qquad [ Equation l ]$$

$$β = {Y}_{a} - α \cdot {X}_{a}$$

Here, for the corresponding luma pixels among the four pairs of pixels, Xₐ and X_{b} each represent the average of the two minimum values and the average of the two maximum values. Additionally, for the chroma pixels, Yₐ and Y_{b} each represent the average of the two minimum values and the average of the two maximum values. Then, the video decoding device may generate a predictor pred_{C}(i,j) of the current chroma block from the pixel values rec′_{L}(i,j) of the corresponding luma region by using a linear model, as shown in Equation 2.

pred_{C}(i,j)=α·rec′_{L}(i,j)+β [Equation 2]

Before the linear model is applied, the video decoding device checks for equality between the size of the corresponding luma region and the size of the current chroma block. If the sizes are different, depending on the subsampling scheme of the chroma channel, the video decoding device may apply downsampling to the corresponding luma region to adjust the size of the corresponding luma region to be equal to the size of the current chroma block.

As described above, the CCLM mode is divided into three modes, CCLM_LT, CCLM_L, and CCLM_T, according to the positions of neighboring pixels used in the derivation process of the linear model. CCLM_LT mode, as illustrated in FIG. 6, uses two pixels in each direction among the left and top neighboring pixels of the current chroma block. CCLM_L uses four pixels among the left neighboring pixels of the current chroma block. Finally, CCLM_T uses four pixels among the top neighboring pixels of the current chroma block.

### II. Intra Prediction of Current Chroma Block Based on Embodiments of Present Disclosure

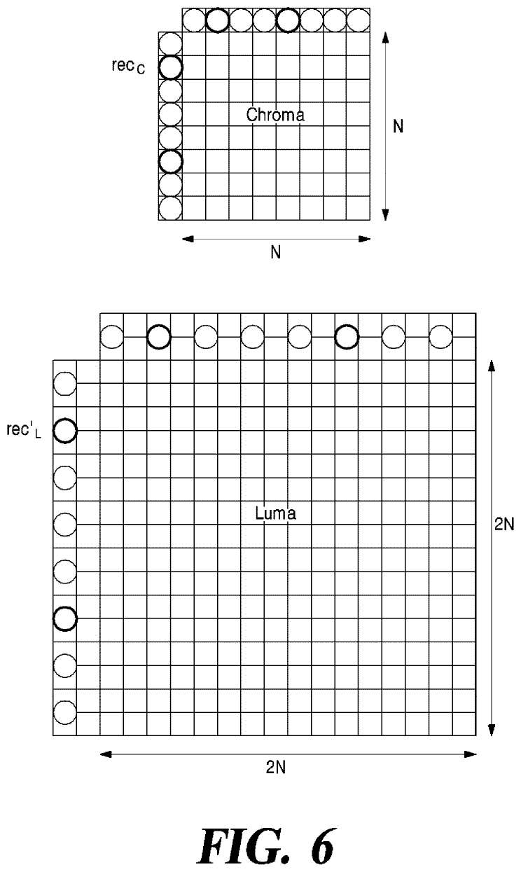

FIG. 7 is a diagram illustrating information available to a chroma channel in intra prediction.

For the intra prediction of a chroma channel, the video decoding device may utilize a method of generating a predictor by using \textcircled{1} information of a corresponding luma region, or a method of generating a predictor by using \textcircled{2} information of the same channel. In the VVC technique, there are various schemes for each method, and these schemes are categorized by prediction mode. Additionally, by indicating the prediction mode, a predictor generation method may be specified. Hereinafter, setting the predictor generation method is described as setting the prediction mode. Hereinafter, generating a predictor by using the \textcircled{1} information of the corresponding luma region is expressed as ‘cross-component prediction’ and the method is expressed as ‘cross-component prediction mode’ or ‘cross-component prediction method’. Additionally, generating a predictor by using the \textcircled{2} information of the same channel is referred to as ‘same-channel prediction’ and the method is referred to as ‘same-channel prediction mode’ or ‘same-channel prediction method’.

For example, among the intra-prediction methods of the chroma channel in the VVC technique, the cross-component prediction method using the \textcircled{1} information of the corresponding luma region includes the CCLM mode as described above. Other cross-component prediction methods include deriving a plurality of linear models between the corresponding luma region and the current chroma block and using the linear models to perform prediction, deriving a linear model by using a gradient value (i.e., a change value) based on a pixel value instead of a luma pixel value at a corresponding position and using the linear model to perform prediction, and predicting by using a many-to-one matching that uses a co-located corresponding luma pixel and its neighboring pixel values additionally when one pixel value of the current chroma block is predicted.

On the other hand, among the intra-prediction methods of the chroma channel, the same-channel prediction methods that use the \textcircled{2} information of the same channel include planar, DC, directional mode, and the like. In addition, the same-channel prediction methods include techniques such as Intra Sub Partition (ISP), Matrix-weighted Intra Prediction (MIP), Multiple Reference Line (MRL), and the like. In addition, the same-channel prediction method may be provided by a method for prediction by inferring directional or non-directional modes from multiple reference lines neighboring the current block, and a method for prediction by calculating weights based on the distance between pixels in the corresponding luma region and neighboring pixels in the block and using these weights for weight summing pixels in the current chroma block and neighboring chroma pixels.

On the other hand, when a predictor of a chroma block is generated by using information of a luma region corresponding to the chroma block, such as CCLM prediction, information of neighboring pixels of the current chroma block is not used in the process of generating the predictor, which is an issue. This is because the prior art generates the predictor by using only one of the \textcircled{1} information of the corresponding luma region and the \textcircled{2} information of the same channel. Further, depending on how the chroma channel is subsampled, there is a possibility that the \textcircled{1} information of the corresponding luma region is less significant than the \textcircled{2} information of the same channel, such as neighboring pixels in the current channel. As a result, discontinuities may occur between the predictor generated in CCLM mode and the adjacent neighboring pixels. These issues of the existing techniques can be solved by considering the neighboring pixel information of the current channel when the current channel is predicted according to the CCLM mode. This is to perform the prediction by using the \textcircled{2} information in addition to the \textcircled{1} information. Alternatively, the issues of such prior art can be solved, when prediction is performed by using the information of neighboring pixels in the same channel, e.g., when directional or non-directional intra prediction is performed, by further using the information of the luma region. This is to perform the prediction by using the \textcircled{1} information in addition to the \textcircled{2} information.

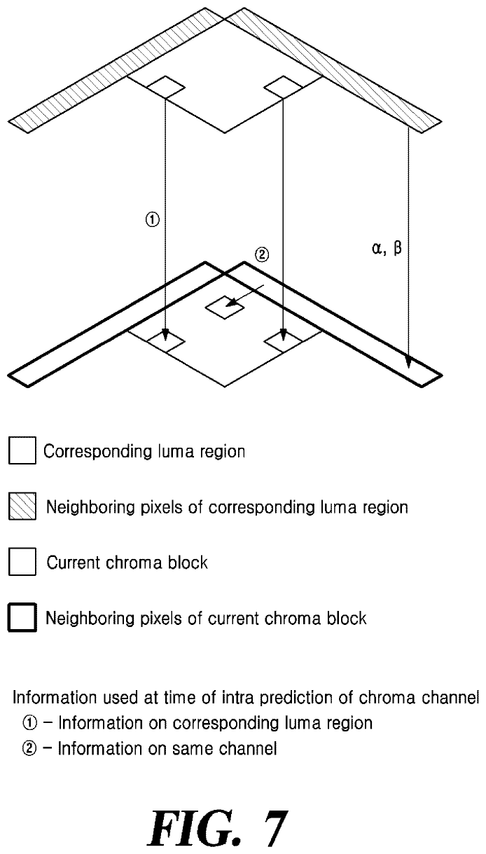

FIG. 8 is a diagram illustrating an intra predictor performing intra prediction of a chroma block, according to at least one embodiment of the present disclosure.

To cope with the issue of using only one of the information of the corresponding luma region and the information of the same channel as described above, the intra predictor 542 in the video decoding device according to at least one embodiment generates a predictor of the current chroma block by weight summing a first predictor based on the CCLM mode and a second predictor further generated based on the intra-prediction mode. Here, the CCLM mode uses the \textcircled{1} information of the corresponding luma region, and the intra-prediction mode uses the \textcircled{2} information of the same channel. The intra-predictor 542 according to at least one embodiment includes all or part of an input unit 802, a first predictor generator 804, a second predictor generator 806, and a weight summer 808. The intra predictor 122 in the video encoding device may also include the same components.

The input unit 802, according to at least one embodiment, obtains a CCLM mode for CCLM prediction of the current chroma block. Alternatively, the input unit 802 may obtain a cross-component prediction mode for cross-component prediction of the current chroma block.

The first predictor generator 804 may perform a CCLM prediction based on the CCLM mode to generate a first predictor of the current chroma block. Alternatively, the first predictor generator 804 may perform a cross-component prediction based on the cross-component prediction mode to generate a first predictor of the current chroma block.

The second predictor generator 806 may generate a second predictor of the current chroma block based on an intra-prediction mode that uses neighboring pixels. For example, the second predictor generator 806 may generate a second predictor based on a same-channel prediction mode that uses same-channel information.

The weight summer 808 uses weights to weight sum the first predictor and the second predictor, thereby generating the intra-predictor of the current chroma block.

At this time, the video decoding device may weight sum the first predictor and the second predictor by using weights as shown in Equation 3.

pred_{C}(i,j)=w_{CCLM}(i,j)·pred_{CCLM}(i,j)+(1−w_{CCLM}(i,j))·predᵢₙₜᵣₐ(i,j) [Equation 3]

Here, (i,j) represents the position of the pixel, pred_{C}(i,j) represents the intra predictor of the current chroma block. pred_{CCLM}(i,j) denotes the first predictor, predᵢₙₜᵣₐ(i,j) denotes the second predictor, and w_{CCLM}(i,j) denotes the weight. As described above, pred_{CCLM}(i,j) denotes a predictor based on CCLM predictions, but may comprehensively denote a predictor based on cross-component predictions.

Hereinafter, the second predictor and ‘additional predictor’ are used interchangeably. If there are multiple (e.g., n) additional predictors, another predᵢₙₜᵣₐ may be added to Equation 3, and the weights may be partitioned and distributed for each additional predictor within 1-w_{CCLM} (i,j).

In Equation 3, the weights are expressed in terms of w_{CCLM}, but may also be implemented in terms of wᵢₙₜᵣₐ, as shown in Equation 4, depending on the embodiments.

pred_{C}(i,j)=(1−wᵢₙₜᵣₐ(i,j))·pred_{CCLM}(i,j)+wᵢₙₜᵣₐ(i,j)·predᵢₙₜᵣₐ(i,j) [Equation 4]

The second predictor according to the same-channel prediction mode and the first predictor according to the CCLM mode may be weight summed as shown in Equation 4. In Equation 4, the predictor according to the same-channel prediction mode may be referred to as the first predictor and the predictor according to the CCLM mode may be referred to as the second predictor. In this case, similar to the example illustrated in FIG. 8, the video decoding device may parse the intra-prediction mode for generating the first predictor by using the same-channel information, and the video decoding device may parse the CCLM mode for generating the second predictor by using the information in the corresponding luma region. Thus, it should be understood that, depending on the implementation, the first predictor and the second predictor may include both the cases shown in Equation 3 and Equation 4.

Hereinafter, unless otherwise noted, for ease of description, the predictor according to the CCLM mode is referred to as the first predictor, and the predictor according to the intra-prediction mode that uses neighboring pixel information is referred to as the second predictor, and the weights expressed with respect to w_{CCLM} shown in Equation 3 are used. Further, as illustrated in FIG. 8, the CCLM prediction mode for generating the first predictor may be parsed and the intra-prediction mode for generating the second predictor may be inferred.

Hereinafter, the term ‘adjacent’ refers to two targets when spatially contiguous, and the term ‘neighboring’ refers to the spatial sense that another target exists within a certain distance with respect to one target, including the sense of ‘adjacent’. If the information of the channel is to be displayed, this is specified in the context. Although the temporal meaning of ‘neighboring’ is not separately mentioned, subsequent implementations may also be implemented in corresponding positions in other frames.

The video decoding device may autonomously infer an intra-prediction mode that uses neighboring pixels, or the video decoding device may use a prediction mode transmitted in the bitstream by the video encoding device. Further, the video decoding device may autonomously infer the method of weight summing the first predictor and the second predictor or may use such a method as transmitted in the bitstream by the video encoding device. The method of inferring/transmitting the intra-prediction mode and the method of inferring/transmitting the weights may be variously combined. For example, the intra-prediction mode may be inferred by the video decoding device and the weight summing method may be transmitted over the bitstream. Conversely, the intra-prediction mode may be transmitted over the bitstream and the weight summing method may be inferred by the video decoding device. Preferred implementations of these various combinations are described below.

### <Implementation 1> Inferring a Method of Generating Predictors to be Weight-Summed

This implementation infers a method of generating a second predictor (predᵢₙₜᵣₐ) that uses neighboring pixels of the same channel, according to Equation 3. According to this implementation, the video decoding device may set a preset prediction mode to the prediction mode of the second predictor without the prediction mode of the second predictor being explicitly signaled by the video encoding device. Alternatively, the video decoding device may infer at least one or more prediction modes of the second predictor based on at least one or more information items on the following: the current chroma block's neighboring chroma blocks' width/height/area/aspect ratio/prediction mode/position/number/distance to the current chroma block, the neighboring chroma pixels' value/position/number/distance to the current chroma block, the corresponding luma region's internal blocks' and their neighboring blocks' width/height/area/aspect ratio/prediction mode/position/number, and the corresponding luma region's internal and neighboring luma pixels' value/position/number. Here, the corresponding luma region's internal blocks are defined as blocks that are fully or partially included in the corresponding luma region.

On the other hand, this implementation according to Equation 4 may parse the same-channel prediction mode for generating the intra predictor predᵢₙₜᵣₐ as described above, and it may infer a method of generating the predictor pred_{CCLM} that uses the information of the corresponding luma region. According to this implementation, the video decoding device may set a preset prediction mode to the prediction mode of the pred_{CCLM} without explicitly receiving a signaled prediction mode of the pred_{CCLM} from the video encoding device. Alternatively, the video decoding device may infer at least one or more prediction modes of the pred_{CCLM} based on at least one or more information items on the following: the current chroma blocks' width/height/area/aspect ratio/prediction mode/position/number/distance to the current chroma block, the neighboring chroma pixels' value/position/number/distance to the current chroma block, the corresponding luma region's internal blocks' and their neighboring blocks' width/height/area/aspect ratio/prediction mode/position/number, and the corresponding luma region's internal and neighboring luma pixels' value/position/number.

### <Implementation 1-1> Setting a Predefined Prediction Mode as a Prediction Mode of the Second Predictor

In this implementation, according to Equation 3, the video decoding device sets the predefined prediction mode as the prediction mode of the second predictor predᵢₙₜᵣₐ. In this case, the available prediction modes may be modes that generate predictors based on neighboring pixels, such as the 67 intra-prediction modes (IPMs) illustrated in FIG. 3A, matrix-weighted intra-prediction modes (MIP modes), and the like. For example, when one second predictor (i.e., when n is 1) is used, the prediction mode of the second predictor may be planar mode. Thus, by applying Equation 3, the video decoding device may generate a predictor of the current chroma block as shown in Equation 5.

pred_{C}(i,j)=w_{CCLM}(i,j)·pred_{CCLM}(i,j)+(1−w_{CCLM}(i,j))·predₚₗₐₙₐᵣ [Equation 5]

As another example, when two additional predictors are used (i.e. when n is 2), the prediction mode of each additional predictor may be planar mode and DC mode. Thus, the video decoding device may generate a predictor of the current chroma block as shown in Equation 6.

pred_{C}(i,j)=w_{CCLM}(i,j)·pred_{CCLM}(i,j)+(1−w_{CCLM}(i,j))·{w₁·predₚₗₐₙₐᵣ+w₂·pred_{DC}} [Equation 6]

Here, the weights of the additional predictors satisfy an equation that w1+w2=1. The present implementation refers to the preset prediction mode as the ‘representative mode’ as described hereinafter.

On the other hand, this implementation according to Equation 4 may preset a prediction mode of the second predictor pred_{CCLM} that uses information of the corresponding luma region. Such a mode may be at least one of the cross-component prediction modes as described above. In this case, this implementation may parse the same-channel prediction mode for generating a predictor by using the same-channel information.

### <Implementation 1-2> Using Reconstructed Chroma Information Around the Current Chroma Block

In this implementation, the video decoding device sets as the second predictor's prediction mode the prediction mode that is derived by using the current chroma block's neighboring reconstructed chroma information, i.e., information such as the current chroma block's neighboring pixels' value/position/number/distance to the current chroma block, wherein the derived prediction mode is referred to as ‘representative mode’ hereinafter. In this case, the number of representative modes derived by the video decoding device depends on the number of additional predictors that are weight summed.

On the other hand, the method of setting the representative mode according to the present implementation may be applied when the second predictor is pred_{CCLM} or predᵢₙₜᵣₐ. Hereinafter, the derivation of the representative mode is described for the case where the second predictor is predᵢₙₜᵣₐ.

The video decoding device may use one of the following methods for deriving the representative mode.

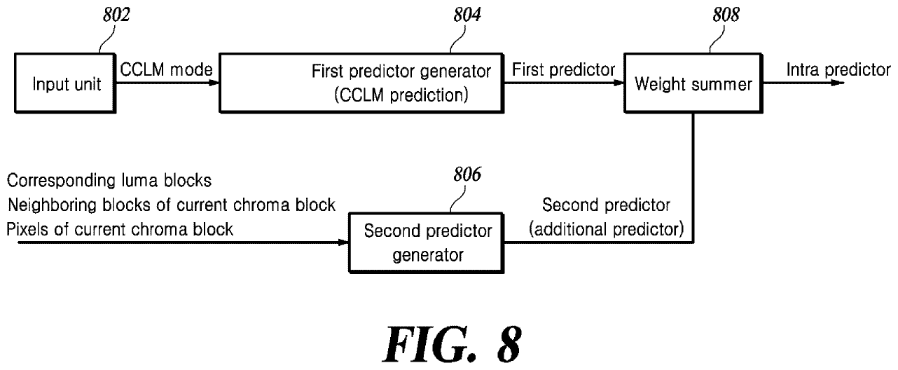

A first method may use an edge detection filter to set as the representative mode the prediction mode having the largest intensity among the prediction modes derived from the values of neighboring pixels of the current chroma block. For this purpose, the video decoding device may borrow the method used to derive the prediction mode from the Decoder-side Intra Mode Derivation (DIMD) technique as follows. First, as shown in the example of FIG. 9, a ‘neighboring chroma pixel region’ including neighboring pixels of the current chroma block is set. At this time, the neighboring chroma pixel region may be set variously according to embodiments other than the example of FIG. 9.

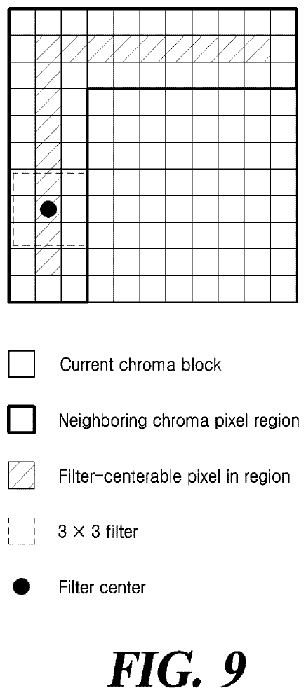

The video decoding device applies an edge detection filter, such as a Sobel filter, a Prewitt filter, a Robert cross filter, or the like, to the established neighboring chroma pixel region, as shown in the example of FIG. 9. The video decoding device calculates the gradient for each pixel in the region and substitutes the calculated gradient with the directional mode of the intra prediction. The video decoding device may derive an intensity (I) for the directional mode based on the magnitude of the slope value, and then accumulate the intensities for the respective directional modes to generate an intensity histogram, as shown in the example of FIG. 10. In the example of FIG. 10, I_{IPM} represents the intensity of each directional mode. The video decoding device may use mode 19 as a representative mode because the mode 19 is the directional mode with the largest intensity in the histogram illustrated in FIG. 10.

When a plurality of representative modes are inferred, the directional modes having the largest intensity after mode 19 in the histogram may be used as representative modes in order of magnitude.

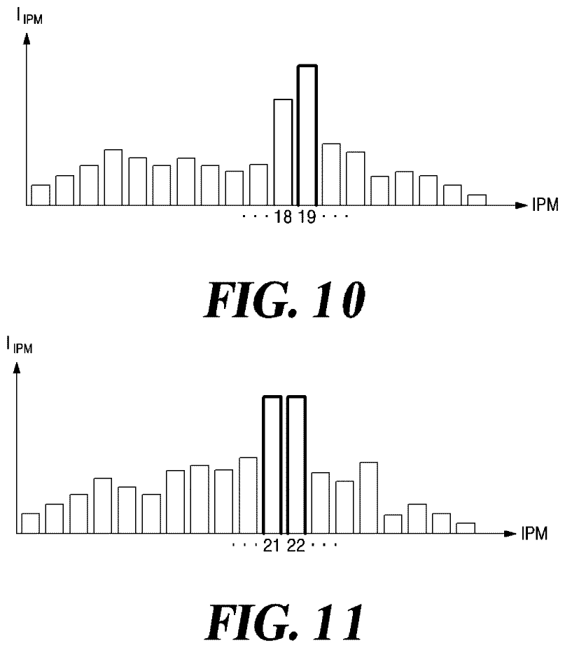

If the directional modes have the same intensity, the representative mode may be derived by prioritizing the directional modes having the same intensity. In this case, used as the priority may be a predetermined order such as {horizontal mode, vertical mode, mode 66, . . . }, ascending order, or descending order. For example, in the example of FIG. 11, when prioritizing in descending order, mode 22 has a higher priority because mode 22 is larger in the index than mode 21. Therefore, the video decoding device may derive mode 22 as a representative mode.

In addition to the above example, the representative mode may be inferred according to a predetermined rule when the intensity is the same.

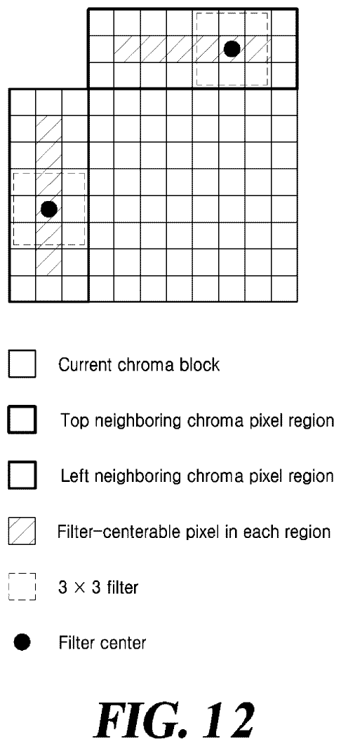

As another example, the video decoding device may divide neighboring pixels by the left and top neighboring chroma pixel regions of the current chroma block to derive a plurality of representative modes, and then may calculate a histogram for each of the neighboring pixel regions, as shown in the example of FIG. 12, and use the directional mode with the largest intensity as the representative mode.

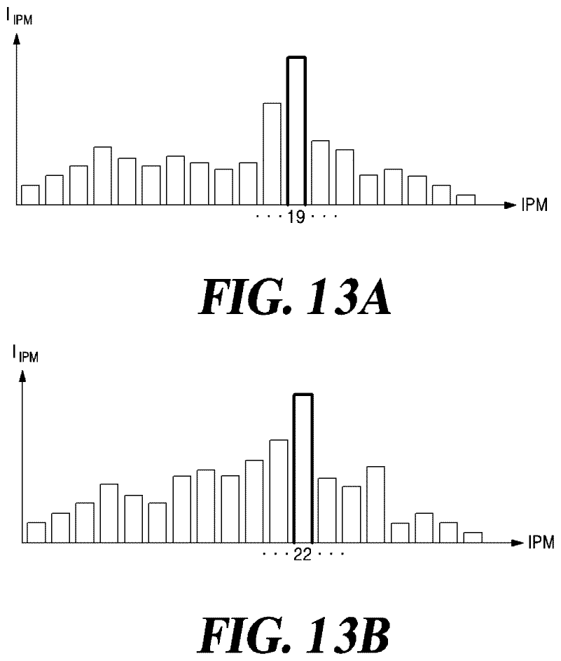

For example, when the intensity histograms derived from the top and left neighboring pixel regions are as in the examples of FIG. 13A and FIG. 13B, the video decoding device may use, as representative modes, mode 19 derived from the histogram illustrated in FIG. 13A and mode 22 derived from the histogram illustrated in FIG. 13B.

On the other hand, since the prediction modes that may be inferred by using the edge detection filter as described above are limited to directional prediction modes, the present implementation may be limited to the case where the second predictor is predᵢₙₜᵣₐ according to Equation 3.

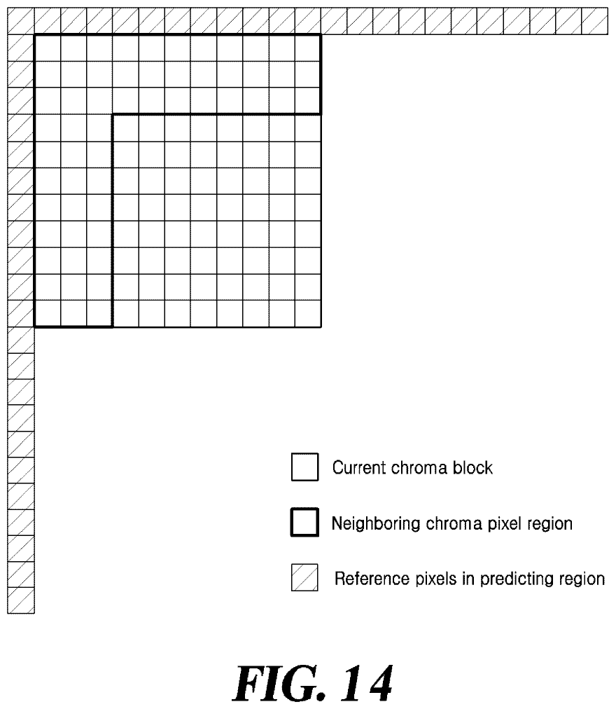

As a second method, the distortions of the prediction modes may be compared by using information of neighboring pixels of the current chroma block, and the prediction mode having the smallest distortion may be set as the representative mode. For this purpose, the video decoding device may borrow the method used by the template-based intra-prediction mode derivation (TIMD) technique to derive the prediction mode as follows. First, a neighboring chroma pixel region of the current chroma block is established as illustrated in FIG. 14. The video decoding device generates a predictor of the neighboring chroma pixel region by performing a prediction for the respective prediction mode candidates by using the left and top neighboring pixels of the region. In the example of FIG. 14, the neighboring pixels referenced in generating the predictor are limited to neighboring pixels adjacent to the set neighboring chroma pixel region, but they may also include neighboring pixels slightly distant from the set region. Furthermore, the neighboring chroma pixel region may be varied according to embodiments.

On the other hand, if the second predictor is predᵢₙₜᵣₐ, the prediction mode candidates may be prediction modes that generate predictors based on neighboring pixels, such as IPM (intra-prediction mode), MIP mode (matrix-weighted intra-prediction mode), and the like. Additionally, if the second predictor is pred_{CCLM}, the prediction mode candidates may be one of the cross-component prediction modes, which generates predictors based on information on the corresponding luma region.

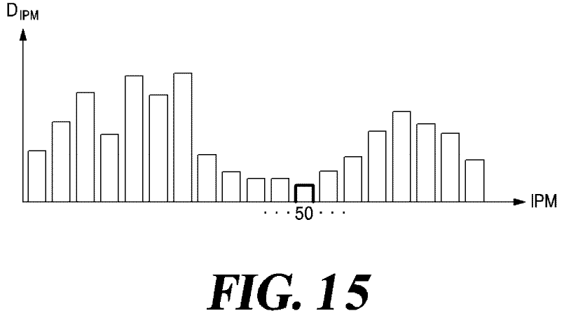

The video decoding device then calculates the distortion (D) between the predictor of a neighboring chroma pixel region according to the respective prediction mode candidates and the reconstructed pixel values of that region. At this time, various image similarity measures may be used, such as Mean Square Error (MSE), Sum of Absolute Differences (SAD), Sum of Absolute Transformed Differences (SATD), and the like. The video decoding device uses the prediction mode with the smallest distortion among the prediction mode candidates as the representative mode. For example, in the example of FIG. 15, when a distortion (D_{IPM}) histogram is generated for the prediction mode candidates, mode 50 has the smallest distortion. Therefore, the video decoding device may use mode 50 as the representative mode. When a plurality of representative modes are derived, or when some prediction mode candidates have the same distortion, the first method described above may be equally employed after replacing the selection criteria for the representative mode with the order of increasing distortion.

To derive a representative mode from the values of neighboring pixels for the current chroma block, the representative mode may be derived by using a variety of methods in addition to the two examples described above.

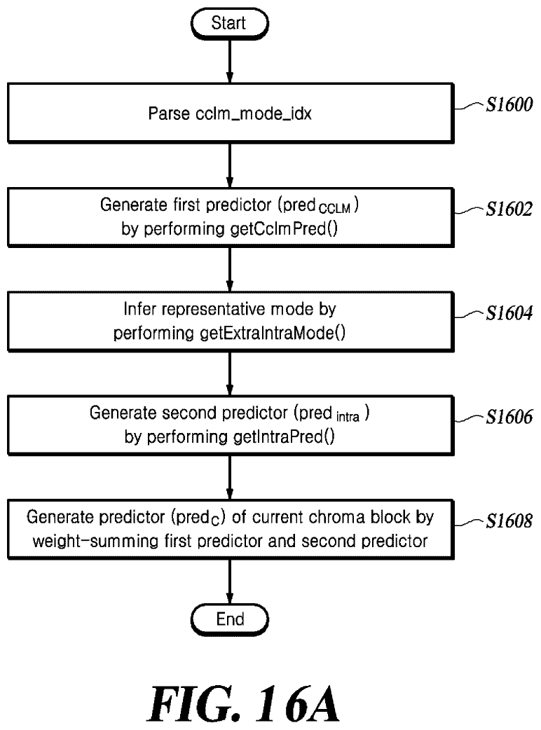

The following describes by referring to FIGS. 16A and 16B, a method for intra prediction of the current chroma block, which uses a weighted sum of the first predictor and the second predictor.

FIGS. 16A and 16B are flowcharts of an intra-prediction method for the current chroma block, according to at least one embodiment of the present disclosure.

First, when the first predictor is pred_{CCLM} as shown in Equation 3, an intra-prediction method of the current chroma block is described according to the example of FIG. 16A.

The video decoding device parses cclm_mode_idx (S1600). The video decoding device may parse the index, cclm_mode_idx to obtain a CCLM mode for application to the current chroma block. Alternatively, the video decoding device may parse an index to obtain a cross-component prediction mode for application to the current chroma block. The cclm_mode_idx or the cross-component prediction mode may be determined by the video encoding device in terms of optimizing coding efficiency.

The video decoding device may generate a first predictor (pred_{CCLM}) by performing an existing getCclmPred( ) function with the parsed CCLM mode as input (S1602). Alternatively, the video decoding device may generate a first predictor by using the parsed cross-component prediction mode as input.

The video decoding device performs a getExtraIntraMode( ) function to infer the representative mode (S1604). The getExtraIntraMode( ) function is hereinafter referred to as the ‘representative mode derivation function’ or ‘derivation function’ for short.

The video decoding device generates a second predictor (predᵢₙₜᵣₐ) by performing the already existing getIntraPred( ) function by using the representative mode as input (S1606).

The video decoding device generates a predictor (pred_{C}) of the current chroma block by weight-summing the first predictor and the second predictor (S1608).

Next, when the first predictor is predᵢₙₜᵣₐ as shown in Equation 4, a method of predicting the intra of the current chroma block is described according to the example of FIG. 16B.

The video decoding device parses intra_chroma_pred_mode (S1620). By parsing the index, intra_chroma_pred_mode, the video decoding device obtains an intra-prediction mode for applying to the current chroma block. The intra_chroma_pred_mode may be determined by the video encoding device in terms of optimizing coding efficiency.

The video decoding device generates a first predictor (predᵢₙₜᵣₐ) by performing a conventional getIntraPred( ) function by using the parsed intra mode as input (S1622).

The video decoding device performs a getExtraIntraMode( ) function to infer a representative mode (S1624).

The video decoding device generates a second predictor (predᵢₙₜᵣₐ) by performing an existing getCclmPred( ) function by using the representative mode as input (S1626).

The video decoding device generates a predictor (pred_{C}) of the current chroma block by weight-summing the first predictor and the second predictor (S1628).

In this case, the derivation function getExtraIntraMode( ) for deriving the representative mode may be implemented in various ways according to the various representative mode-deriving methods of Implementations 1-2. Hereinafter, the operation of getExtraIntraMode( ) is described with reference to the example of FIG. 16A, but the same may be described with reference to the example of FIG. 16B. In the present implementation, getExtraIntraMode( ) may be provided with the current chroma block's top-left pixel coordinates (x0, y0), width, and height as default inputs.

The following describes the behavior of the derivation function getExtraIntraMode(x0, y0, width, height) according to the first method of Implementation 1-2.

The derivation function establishes a neighboring chroma pixel region from which to derive the representative mode based on the current block's top-left pixel's coordinates (x0,y0), width, and height.

The derivation function generates an intensity histogram as follows.

For example, the derivation function generates an intensity histogram in the form of a list with a length equal to the number of preset directional mode candidates and then initializes the generated intensity histogram to zero. The derivation function positions the filter within the neighboring chroma pixel region according to the preset filter size, and the derivation function derives the slope value of the pixel region positionally overlapped with the filter and derives the intensity. The derivation function replaces the slope value with the directional mode index. The derivation function uses the directional mode index as the position index in the histogram list and accumulates the derived intensities at that position. The derivation function repeats the above tasks while moving the center position of the filter until all points that could be the filter's center position within the neighboring chroma pixel region are searched over.

The derivation function derives the position index with the largest intensity value from the intensity histogram and outputs the directional mode index corresponding to the position index as the representative mode.

The following describes the behavior of the derivation function getExtraIntraMode(x0, y0, width, height) according to the second method of Implementation 1-2.

The derivation function establishes the neighboring chroma pixel region to derive the representative mode based on the current block's top-left pixel's coordinates (x0,y0), width, and height, and selects a range of reference pixels to predict the established region.

The derivation function generates a distortion histogram as follows.

For example, the derivation function pairs the preset prediction mode candidate with that mode's distortion, establishes the distortion histogram in the form of a vector with such pairs used as its components, and initializes the distortion of all candidates to 0. The derivation function uses the first component in the vector, prediction mode candidate, to generate a predictor of the neighboring chroma pixel region from the reference pixels. Using a preset image similarity comparison measure, the derivation function calculates the distortion between the generated predictor and the reconstructed pixel values in the neighboring chroma pixel region. The derivation function updates the second component in the vector with the derived distortion value. The derivation function repeats the above operation for all prediction mode candidates in the vector.

The derivation function outputs as the representative mode the prediction mode paired with the smallest distortion value from the distortion histogram.

The above-described behavior of the derivation function getExtraIntraMode( ) for both types of representative mode-deriving methods, describes the case of generating a single representative mode. If multiple representative modes are to be generated, the derivation function may be extended by further inputting numExtraMode indicating the number of representative modes.

On the other hand, the representative mode inferred by getExtraIntraMode( ) may be the same kind of prediction mode as the prediction mode of the existing predictor, or no representative mode may be inferred at all. In such cases, the next highest priority prediction mode may be used as the representative mode during the inference process. Alternatively, the representative mode may be inferred by using yet another inference method, or a preset mode may be used as the representative mode.

### <Implementation 1-3> Using Reconstructed Information in and Around the Corresponding Luma Region

In this implementation, according to Equation 3, the video decoding device sets as the prediction mode of the second predictor (predᵢₙₜᵣₐ) the prediction mode (hereinafter the ‘representative mode’) derived by using the reconstructed information in and around the luma region (hereinafter the ‘corresponding luma region’) corresponding to the current chroma block, i.e., by using the value/position/number of pixels in and neighboring the corresponding luma region. At this time, the number of representative modes derived by the video decoding device depends on the number of second predictors that are weight summed. However, since the present implementation uses only the reconstructed information in and around the corresponding luma region, it may not infer a prediction mode (e.g., CCLM mode) for generating a chroma predictor by using the information of the corresponding luma region.

The video decoding device may use one of the following methods as a deriving method of the representative mode.

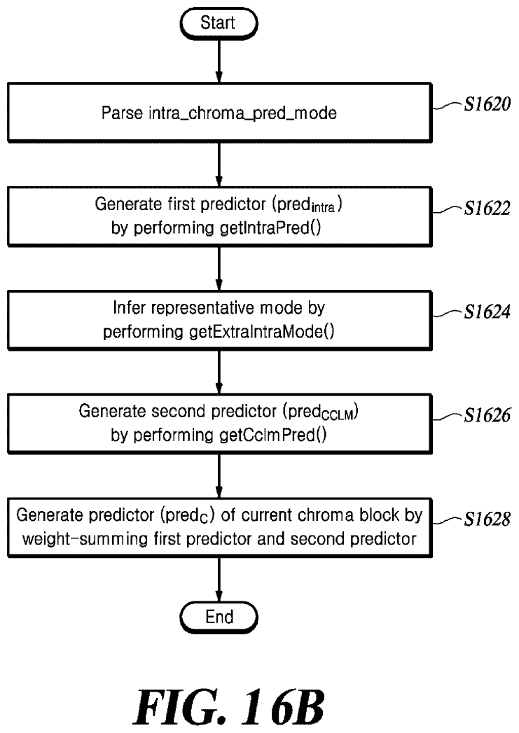

In the first method, the most dominant prediction mode, among prediction modes derived from values of pixels in and neighboring the corresponding luma region by using an edge detection filter, may be set as the representative mode. For this purpose, the video decoding device may borrow the method used in the DIMD technique to derive the prediction mode. First, as shown in the example of FIG. 17, a specific region of pixels within the corresponding luma region is set as a ‘luma pixel region’. In the example of FIG. 17, although a specific region of pixels within the corresponding luma region is set as the ‘luma pixel region’, the luma pixel region may be variably set by embodiments, including neighboring pixels of the corresponding luma region.

Thereafter, the video decoding device may derive the one or plurality of representative modes in the same manner as the first method of deriving the representative modes of Implementations 1-2.

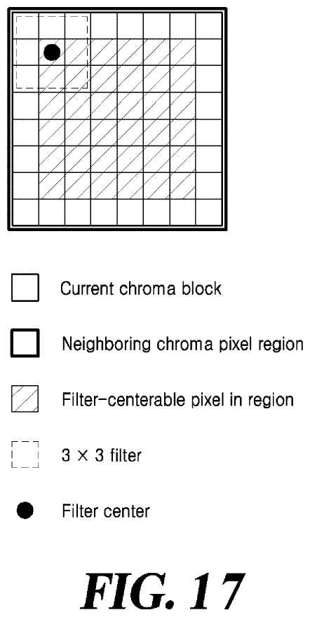

As a second method, the distortions of the respective prediction modes may be compared by using information of pixels within and neighboring the corresponding luma region, and the prediction mode with the smallest distortion may be set as the representative mode. To do so, the video decoding device may borrow the method used in the TIMD technique to derive the prediction mode. First, as shown in the example of FIG. 18, the video decoding device sets a luma pixel region including pixels within the corresponding luma region and neighboring pixels. The video decoding device generates a predictor by performing a prediction for each of the prediction mode candidates by using the left and top neighboring pixels of the region. In the example of FIG. 18, the neighboring pixels referenced in generating the predictor are limited to neighboring pixels adjacent to the set luma pixel region, the neighboring pixels may also include neighboring pixels slightly distant from the set region. Additionally, in the example of FIG. 18, the luma pixel region is limited to pixels within the corresponding luma region, but the luma pixel region may be set variously according to embodiments, including all the pixels within the corresponding luma region and neighboring pixels.

The video decoding device may then derive the one or plurality of representative modes in the same manner as the second method of deriving the representative modes of Implementation 1-2.

To derive the representative mode from the values of the pixels in the corresponding luma region and their neighboring pixels, the representative mode may be derived by using various other methods than the two examples described above.

On the other hand, when the second predictor to be weight summed is predᵢₙₜᵣₐ as shown in Equation 3, the example of FIG. 16A may illustrate a process for generating a final predictor in the present implementation. In this case, the derivation function getExtraIntraMode( ) for inferring the representative mode may be implemented in various ways according to the various representative mode-deriving methods of Implementations 1-3. In this implementation, getExtraIntraMode( ) may be provided with the current chroma block's top-left pixel's coordinates (x0, y0), width, and height as default inputs.

The following describes the behavior of the derivation function getExtraIntraMode(x0, y0, width, height) according to the first method of Implementations 1-3.

The derivation function sets a luma pixel region to derive the representative mode from the pixels inside the corresponding luma region and its neighboring pixels based on the coordinates (x0,y0), width, and height of the top-left pixel of the current block.

The derivation function generates an intensity histogram as follows.

For example, the derivation function generates an intensity histogram in the form of a list with a length equal to the number of preset directional mode candidates and initializes the generated intensity histogram to 0. The derivation function positions the filter within the luma pixel region according to the preset filter size and derives the slope value and intensity of the pixel region positionally overlapping with the filter. The derivation function replaces the slope value with the directional mode index. Using the directional mode index as the position index in the histogram list, the derivation function accumulates the derived intensities at that position. The derivation function repeats the above tasks while moving the center position of the filter until all points that could be the filter's center position within the luma pixel region are searched over.

The derivation function derives the position index with the largest intensity value from the intensity histogram and outputs the directional mode index corresponding to the position index as the representative mode.

The following describes the behavior of the derivation function getExtraIntraMode(x0, y0, width, height) according to the second method of Implementations 1-3.

The derivation function sets a luma pixel region to derive a representative mode from the pixels inside the corresponding luma region and its neighboring pixels based on the current block's top-left pixel's coordinates (x0,y0), width, and height, and selects a range of reference pixels to predict the set region.

The derivation function generates a distortion histogram as follows.

For example, the derivation function pairs a predetermined prediction mode candidate with the distortion of that mode, sets a distortion histogram in the form of a vector with the pairs as the components, and initializes the distortion of all candidates to zero. The derivation function generates a predictor of the luma pixel region from the reference pixels by using the first component in the vector, which is the prediction mode candidate. The derivation function uses a preset image similarity comparison measure to calculate the distortion value between the generated predictor and the reconstructed pixel values of the luma pixel region. The derivation function updates the second component in the vector with the derived distortion value. The derivation function repeats the above tasks for all prediction mode candidates in the vector.

The derivation function outputs as the representative mode the prediction mode paired with the smallest distortion value from the distortion histogram.

The above-described behavior of the derivation function getExtraIntraMode( ) for both types of representative mode-deriving methods, describes the case of generating a single representative mode. When multiple representative modes are generated, the derivation function may be extended by further providing numExtraMode indicating the number of representative modes.

On the other hand, the representative mode inferred by getExtraIntraMode( ) may be the same kind of prediction mode as the prediction mode of the existing predictor, or no representative mode may be inferred at all. In this case, the next highest priority prediction mode may be used as the representative mode during the inference process. Alternatively, the representative mode may be inferred by using yet another inference method, or a preset mode may be used as the representative mode.

### <Implementation 1-4> Implementation 1-1 to Implementation 1-3 Combined

In this implementation, when a plurality of second predictors are generated according to Equation 3 or Equation 4, the video decoding device may select and use one of the methods presented in Implementation 1-1 to Implementation 1-3 to infer a prediction mode (hereinafter a ‘representative mode’) that generates each second predictor. The foregoing implementations have described simultaneously inferring a plurality of representative modes with one particular method within each implementation. In this implementation, the video decoding device may use different methods to infer the representative modes when each second predictor is generated.

For example, when two additional predictors are generated, the video decoding device may use Implementation 1-1 to infer a first representative mode and use Implementation 1-2 to infer a second representative mode. Alternatively, the first representative mode may be inferred based on the first method in Implementation 1-2 for deriving a prediction mode with the greatest intensity, and the second representative mode may be inferred based on the second method in Implementation 1-2 for deriving a prediction mode with the smallest distortion. In other examples, various combinations of inference methods may be envisioned, and as the number of additional predictors increases, more combinations of inference methods may be used.

### <Implementation 2> Method of Setting Weights for Weight Summing

This implementation describes a method based on Equation 3 for weight summing a second predictor generated based on a representative mode inferred according to Implementation 1 and a first predictor generated based on an existing CCLM prediction. The video decoding device may use certain weights as fixed without explicitly receiving the weights as signaled by the video encoding device. In addition, the video decoding device may infer weights based on at least one of the followings: the current chroma block's neighboring chroma blocks' width/height/area/aspect ratio/prediction mode/position/number/distance to the current chroma block, the neighboring chroma pixels' value/position/number/distance to the current chroma block, the corresponding luma region's internal block's and the neighboring blocks' width/height/area/aspect ratio/prediction mode/position/number, and the corresponding luma region's internal and neighboring luma pixels' value/position/number.

The video decoding device may implement various weight summing methods by appropriately setting w(i,j) in Equation 3. Hereinafter, weight summing methods are described for the case where one second predictor (based on the \textcircled{1}) information of the corresponding luma region) is present in addition to the first predictor (based on the \textcircled{2} information of the same channel) generated by the conventional CCLM mode, but the same methods may be applied to the case where multiple additional predictors are present.

Implementations 2-1 through 2-5 below are methods of setting equal weights for all pixels in a predictor. The weight summing method for these implementations is described without considering the effect of pixel coordinates (i,j) within the predictor, as shown in Equation 7.

pred_{C}=w_{CCLM}·pred_{CCLM}+(1−w_{CCLM})·predᵢₙₜᵣₐ [Equation 7]

A method of setting different weights, when based on pixel coordinates (i,j) in the predictor may be described by using the expression of Equation 3.

The foregoing may equally apply to an implementation utilizing Equation 4.

### <Implementation 2-1> Using Predefined Weights

In this implementation, according to Equation 3 or Equation 4, the video decoding device uses a predefined weight w_{CCLM}. The predefined weight may be an equal weight, a higher weight (3:1, 7:1, . . . ) for CCLM prediction, or a lower weight (1:3, 1:7, . . . ) for CCLM prediction.

For example, as shown in Equation 8, the video decoding device may set an equal weight for all predictors.

$${pred}_{C} = \frac{1}{2} \cdot {pred}_{CCLM} + \frac{1}{2} \cdot {pred}_{intra} , ( {w}_{CCLM} = \frac{1}{2} ) \qquad [ Equation 8 ]$$

Alternatively, as shown in Equation 9, the video decoding device may assign a higher weight to the first predictor based on the CCLM prediction.

$${pred}_{C} = \frac{3}{4} \cdot {pred}_{CCLM} + \frac{1}{4} \cdot {pred}_{intra} , ( {w}_{CCLM} = \frac{3}{4} ) \qquad [ Equation 9 ]$$

### <Implementation 2-2> Using Information of Neighboring Chroma Blocks of the Current Chroma Block

In this implementation, according to Equation 3, the video decoding device sets weights by using information such as the current chroma block's neighboring chroma blocks' width/height/area/prediction mode/position/count/distance to the current chroma block. In general, there may be a correlation between the current chroma block and neighboring chroma blocks. Therefore, the correlation may be quantified between the current chroma block and the neighboring chroma blocks that use the prediction mode (hereinafter ‘representative mode’) for generating the second predictor (predᵢₙₜᵣₐ). The quantified correlation is hereinafter referred to as the neighboring pixel correlation r_{C}. The video decoding device may use the neighboring pixel correlation r_{C} to set the value of the weight w_{CCLM}

In this implementation, the representative mode may be one of the 67 intra-prediction modes illustrated in FIG. 3A, as described above. Alternatively, the representative mode may be an intra-prediction mode that collectively represents all 67 intra-prediction modes. If the representative mode is all intra-prediction modes, the non-representative prediction modes may include MIP mode, CCLM mode, and the like.

This implementation when following Equation 4 may infer the prediction mode for generating the predictor (pred_{CCLM}) of the current chroma block (hereinafter ‘representative mode’), and the neighboring pixel correlation r_{C} of the predictor (pred_{CCLM}) by using the information of the neighboring blocks of the current chroma block. The value of the weight wᵢₙₜᵣₐ may then be set by using the neighboring pixel correlation r_{C}.

The video decoding device may use one of the following three methods for deriving the neighboring pixel correlation r_{C}.

In the examples of the methods below, the neighboring chroma blocks contemplated may be blocks adjacent to the current chroma block, but the range of neighboring chroma blocks may vary depending on the embodiment, including blocks that are some distance away from the current chroma block.

In the first method, r_{C} may be derived by calculating, based on the number of blocks, the proportion of the representative mode-utilizing neighboring chroma blocks among the neighboring chroma blocks of the current chroma block.

For example, the implementation may calculate the ratio of the number of neighboring blocks that use the representative mode to the total number of neighboring blocks of the current chroma block and may set this ratio to r_{C}. The video decoding device may use this ratio as the weight of the second predictor, as shown in Equation 10, and may set 1 minus the ratio as the weight of the first predictor generated by the CCLM mode.

$${pred}_{C} = {w}_{CCLM} \cdot {pred}_{CCLM} + ( 1 - {w}_{CCLM} ) \cdot {pred}_{intra} , \qquad [ Equation 10 ]$$

$$( {r}_{C} = 1 - {w}_{CCLM} = \frac{number of blocks using representative mode}{number of all neighboring blocks} )$$

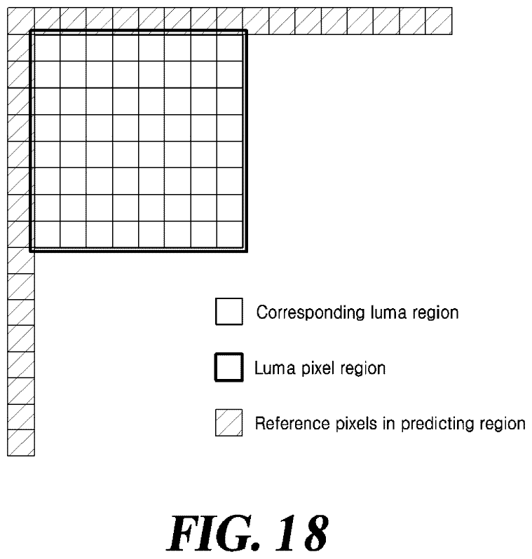

This implement assumes that the current chroma block's neighboring blocks and prediction modes are distributed as shown in the example of FIG. 19. In the example of FIG. 19, there are a total of five neighboring blocks of the current chroma block, of which three neighboring blocks use the representative mode that is the planar mode. Therefore, the video decoding device may set ⅗ as the weight of the second predictor and set ⅖ as the weight of the first predictor generated by the CCLM mode, according to Equation 10. When multiple additional predictors are weight-summed, after calculating the weights of the respective additional predictors by the same method, the video decoding device may set the value of 1 minus the sum of the weights of the additional predictors as the weight of the first predictor.

As a second method, r_{C} may be derived by calculating, based on the block area, the proportion of neighboring chroma blocks that use the representative mode, among the neighboring chroma blocks of the current chroma block.

For example, the implementation may calculate the ratio of the area of the neighboring blocks using the representative mode to the total area of the neighboring blocks of the current chroma block and may set this ratio to r_{C}. The video decoding device may use this ratio as the weight of the second predictor, as shown in Equation 11, and may set 1 minus the ratio as the weight of the first predictor generated by the CCLM mode.

$${pred}_{C} = {w}_{CCLM} \cdot {pred}_{CCLM} + ( 1 - {w}_{CCLM} ) \cdot {pred}_{intra} , \qquad [ Equation 11 ]$$

$$( {r}_{C} = 1 - {w}_{CCLM} = \frac{area of blocks using representative mode}{area of all neighboring blocks} )$$

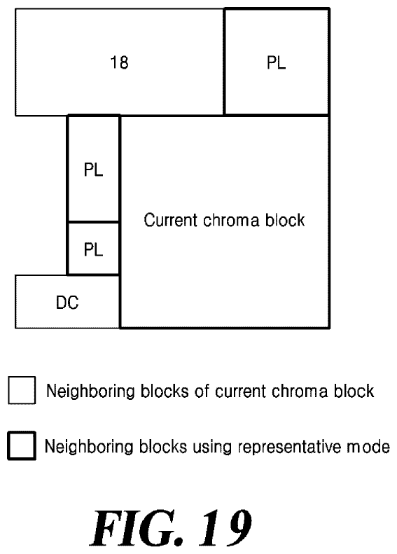

The implementation assumes that the current chroma block's neighboring blocks and the prediction modes are distributed as shown in the example of FIG. 20. In the example of FIG. 20, the total area of the neighboring blocks of the current chroma block is 68, of which 28 is the area of the neighboring blocks using the representative mode, planar mode. Therefore, the video encoding device may set 28/68 as the weight of the second predictor and 40/68 as the weight of the first predictor generated by the CCLM mode according to Equation 11. When multiple additional predictors are weight-summed, after calculating the weights of the respective additional predictors in the same way, the video decoding device may set the value of 1 minus the sum of the weights of the additional predictors as the weight of the first predictor.

As a third method, r_{C} may be derived based on a ratio between the total side lengths of the current chroma block being adjacent to the neighboring chroma blocks and the side length of the neighboring chroma blocks using the representative mode while being adjacent to the current block.

For example, the video decoding device may calculate, out of the total lengths of the current chroma block's sides adjacent to the neighboring chroma blocks, a ratio of the length of sides of the neighboring blocks using the representative mode while being adjacent to the current chroma block, and the video decoding device may set this ratio to r_{C}. The video decoding device may use this ratio as the weight of the second predictor, as shown in Equation 12, and may set 1 minus the ratio as the weight of the first predictor generated by the CCLM mode.

$${pred}_{C} = {w}_{CCLM} \cdot {pred}_{CCLM} + ( 1 - {w}_{CCLM} ) \cdot {pred}_{intra} , \qquad [ Equation 12 ]$$

$$( {r}_{C} = 1 - {w}_{CCLM} = \frac{length of neighboring sides of blocks using representative mode}{length of all neighboring sides of current blocks} )$$

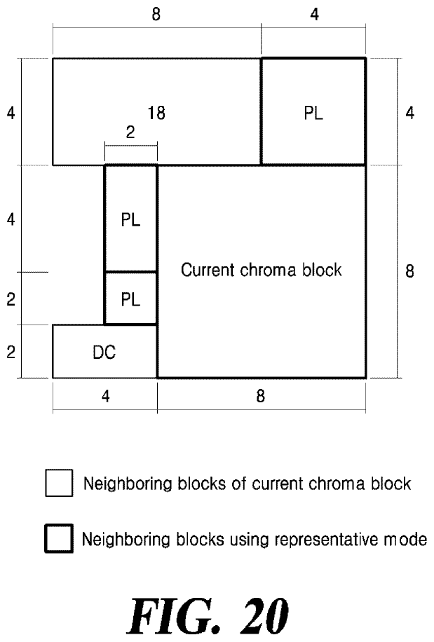

This implement assumes that the current chroma block's neighboring blocks and the prediction modes are distributed as shown in the example of FIG. 21. In the example of FIG. 21, the total side length of the neighboring blocks adjacent to the current chroma block is 16, of which 10 is the side length of the neighboring blocks using the representative mode, planar mode while being adjacent to the current chroma block. Therefore, the video decoding device may set 10/16 as the weight of the second predictor and 6/16 as the weight of the first predictor generated by the CCLM mode according to Equation 12. When multiple additional predictors are weight-summed, after calculating the weights of the respective additional predictors in the same way, the video decoding device may set the value of 1 minus the sum of the weights of the additional predictors as the weight of the first predictor.

The examples of FIGS. 19 through 21 uses one intra-prediction mode, namely, the planar mode, as a representative mode, but as described above, the representative mode may be an intra-prediction mode that collectively represents all 67 intra-prediction modes.

In the present implementation, if the number of total neighboring blocks or the area of total neighboring blocks is not in the form of a power of two in the process of calculating the neighboring pixel correlation r_{C}, the hardware implementation of the method may encounter a significantly increased computational complexity of the division process. Therefore, in the process of deriving the neighboring pixel correlation, the video decoding device may approximate each denominator and numerator to a power of two by using the operation as shown in Equation 13, and then may derive the neighboring pixel correlation by using Equation 10 to Equation 12.

approximated number of adjacent blocks=1 [symbol] Round(log₂ number of adjacent blocks) approximated area of adjacent blocks=1 [symbol] Round(log₂ area of adjacent blocks) [Equation 13]

Alternatively, in the process of calculating the neighboring pixel correlation r_{C}, the video decoding device may further multiply the neighboring pixel correlation by an importance weight p predetermined to adjust the importance of the neighboring pixel correlation. For example, by applying the importance weight p, the neighboring pixel correlation of Equation 10 may be expressed as Equation 14.

$${r}_{C} = 1 - {w}_{CCLM} = \frac{p \cdot umber of blocks using representative mode}{number of all neighboring blocks} \qquad [ Equation 14 ]$$

Alternatively, the video decoding device may approximate the derived weights to the nearest power of ½, ¼, ⅛, or the like. Alternatively, the video decoding device may divide the weights interval between 0 and 1 into equal segments, such as halves, quarters, eighths, or the like, or may divide the weights by using a variable segment length, may select a value at the dividing position as a representative weight value, and may approximate the derived weight to the nearest representative weight value. In addition, the weights may be further adjusted by using various conditional expressions or calculation formulae, depending on the embodiment.

### <Implementation 2-3> Using Information of Blocks Included in the Corresponding Luma Region and their Neighboring Blocks

In this implementation, according to Equation 3, the video decoding device sets the weights by using information such as width/height/area/prediction mode/aspect ratio/location/number of blocks included in the luma region, corresponding to the current chroma block, hereinafter called the ‘corresponding luma region’ and its neighboring blocks. There may be a certain correlation between the current chroma block and the corresponding luma region. Therefore, the correlation may be quantified between the current chroma block and the blocks in the region that uses the prediction mode (hereinafter ‘representative mode’) for generating the second predictor (predᵢₙₜᵣₐ). Hereinafter, the quantified correlation is referred to as luma pixel correlation r_{L}. The video decoding device may use the luma pixel correlation r_{L} to set the value of the weight w_{CCLM}. However, this implementation uses only the information of blocks included in the corresponding luma region and neighboring blocks, so the weight of the representative mode may be derived for a prediction mode, e.g., IPM, which generates a predictor based on neighboring pixel information.

In this implementation, the representative mode may be one of the 67 intra-prediction modes illustrated in FIG. 3A, as described above. Alternatively, the representative mode may be an intra-prediction mode that collectively represents all 67 intra-prediction modes. If the representative mode is the entire set of intra-prediction modes, the non-representative prediction modes may include MIP mode, CCLM mode, and the like.

The video decoding device may use one of the following two methods as a deriving method for the luma pixel correlation r_{L}.

In the following example methods, the blocks considered are those included in the corresponding luma region, but the range of blocks may vary according to embodiments, including neighboring blocks of the corresponding luma region.

A first method may derive IL by calculating, based on the block area, the proportion of blocks that use the representative mode among the blocks in the corresponding luma region.

For example, the implementation may calculate the ratio between the total number of blocks included in the corresponding luma region and the number of blocks using the representative mode and may set this ratio to r_{L}. The video decoding device may utilize this ratio as the weight of the second predictor, as shown in Equation 15, and may set 1 minus the ratio as the weight of the first predictor generated by the CCLM mode.

$${pred}_{C} = {w}_{CCLM} \cdot {pred}_{CCLM} + ( 1 - {w}_{CCLM} ) \cdot {pred}_{intra} , \qquad [ Equation 15 ]$$

$$( {r}_{L} = 1 - {w}_{CCLM} = \frac{number of blocks using representative mode}{number of all blocks in corresponding luma region} )$$

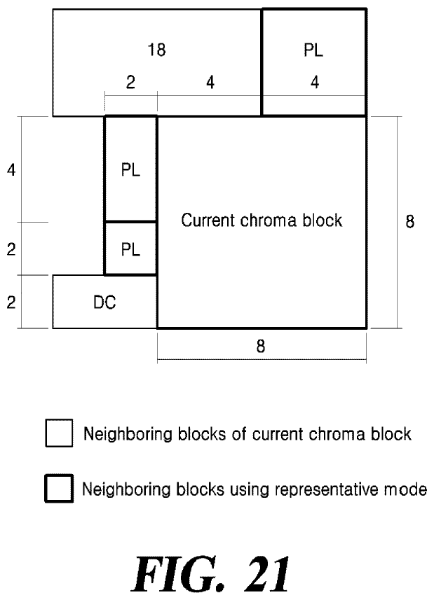

The present implementation assumes that the corresponding luma region's internal blocks and the prediction modes are distributed as shown in the example of FIG. 22. In the example of FIG. 22, the corresponding luma region includes a total of 5 blocks, of which 2 blocks utilize the planar mode that is a representative mode. Therefore, the video decoding device may set ⅖ as the weight of the second predictor and set ⅗ as the weight of the first predictor generated by the CCLM mode according to Equation 15. When multiple additional predictors are weight-summed, after calculating the weights of the respective additional predictors in the same way, the video decoding device may set the value of 1 minus the sum of the weights of the additional predictors as the weight of the first predictor.

A second method may derive IL by calculating, based on the block area, a proportion of the blocks that utilize the representative mode among the blocks included in the corresponding luma region.

For example, the implementation may calculate the ratio between the area of the corresponding luma region and the area of the blocks using the representative mode while being overlapped with the corresponding luma region and may set this ratio to r_{L}. The video decoding device may utilize this ratio as the weight of the second predictor, as shown in Equation 16, and may set 1 minus the ratio as the weight of the first predictor generated by the CCLM mode.

$${pred}_{C} = {w}_{CCLM} \cdot {pred}_{CCLM} + ( 1 - {w}_{CCLM} ) \cdot {pred}_{intra} , \qquad [ Equation 16 ]$$

$$( {r}_{L} = 1 - {w}_{CCLM} = \frac{overlapping area with blocks using representative mode}{area of corresponding luma region} )$$

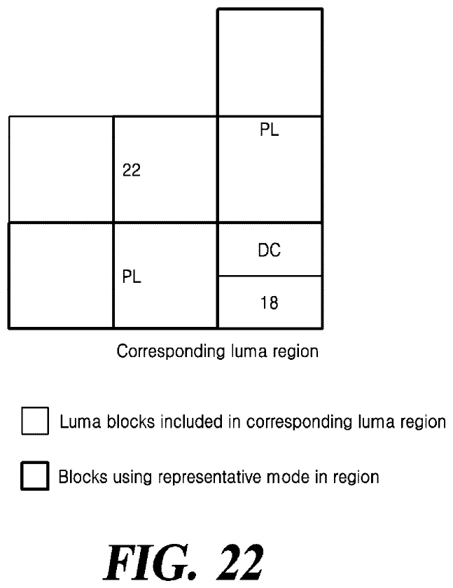

The present implementation assumes that the corresponding luma region's internal blocks and the prediction modes are distributed as shown in FIG. 23. In the example of FIG. 23, the total area of the corresponding luma region is 256, of which 96 is the area of the blocks using the representative mode, planar mode while being overlapped with the corresponding luma region. Therefore, the video decoding device may set 96/256 as the weight of the second predictor and set 160/256 as the weight of the first predictor generated by the CCLM mode according to Equation 16. When multiple additional predictors are weight-summed, after calculating the weights of the respective additional predictors in the same way, the video decoding device may set the value of 1 minus the sum of the weights of the additional predictors as the weight of the first predictor.

In the examples of FIGS. 22 and 23, one intra-prediction mode, namely the planar mode, is used as a representative mode, but as described above, the representative mode may be an intra-prediction mode that collectively represents all 67 intra-prediction modes.

In the present implementation, if the number of blocks using the entire representative modes or the entire overlap area of the blocks overlapping with the corresponding luma region is not in the form of a power of two in the process of calculating the luma pixel correlation r_{L}, the computational complexity of the division process may increase significantly in the hardware implementation. Therefore, in deriving the luma pixel correlation, the video decoding device may approximate each of the denominator and numerator by using operations similar to those shown in Equation 13 to a power of two, and then derive the luma pixel correlation by using Equation 15 and Equation 16.

Alternatively, in the process of calculating the luma pixel correlation r_{L}, the video decoding device may further multiply the luma pixel correlation r_{L} by a predetermined importance weight p to adjust the weight of the luma pixel correlation r_{L}. For example, by applying the importance weight p, the luma pixel correlation of Equation 15 may be expressed as Equation 17.

$${r}_{L} = 1 - {w}_{CCLM} = \frac{p \cdot number of blocks using representative mode}{number of all blocks in corresponding luma region} \qquad [ Equation 17 ]$$

Alternatively, the video decoding device may approximate the derived weights to the nearest power of ½, ¼, ⅛, or the like. Alternatively, the video decoding device may divide the weights interval between 0 and 1 into equal segments, such as halves, quarters, eighths, or the like, or may divide the weights by using a variable segment length, may select a value at the dividing position as a representative weight value, and may approximate the derived weight to the nearest representative weight value. In addition, the weights may be further adjusted by using various conditional expressions or calculation formulae, depending on the embodiment.

### <Implementation 2-4> Using Reconstructed Chroma Information Around the Current Chroma Block

In this implementation, the video decoding device sets the weights by using the reconstructed chroma information around the current chroma block, i.e., the current chroma block's neighboring pixels' value/position/number/distance to the current chroma block. The reconstructed information around the current chroma block may include the neighboring chroma blocks' width/height/area/aspect ratio/prediction mode/position/number/distance to the current chroma block, or the like, but the method of utilizing them depends on Implementation 2-2. Therefore, this implementation primarily describes a method based on information such as the current chroma block's neighboring pixels' value/position/number/distance to the current chroma block. As described above, the region containing the neighboring pixels of the current chroma block is referred to as the neighboring chroma pixel region.

Meanwhile, the weight setting method according to the present implementation may be applied when the second predictor is pred_{CCLM} or predᵢₙₜᵣₐ. The following describes a method of setting a weight where the second predictor is predᵢₙₜᵣₐ.

The video decoding device may use one of the following methods to derive the weights by using the reconstructed chroma information around the current chroma block.

In the first method, the video decoding device may use an edge detection filter to calculate the prediction modes and intensities derived from the values of the neighboring pixels of the current chroma block, and may set as the weight of the second predictor the proportion of the intensity of the representative mode among the total intensities. For this purpose, the video decoding device may borrow the method used by the DIMD technique to derive the prediction mode. This implementation is very similar in behavior to the first method of Implementation 1-2. As mentioned above, since the prediction modes that may be inferred by using the edge detection filter are limited to directional prediction modes, this implementation may be limited to the case where the second predictor is predᵢₙₜᵣₐ according to Equation 3.

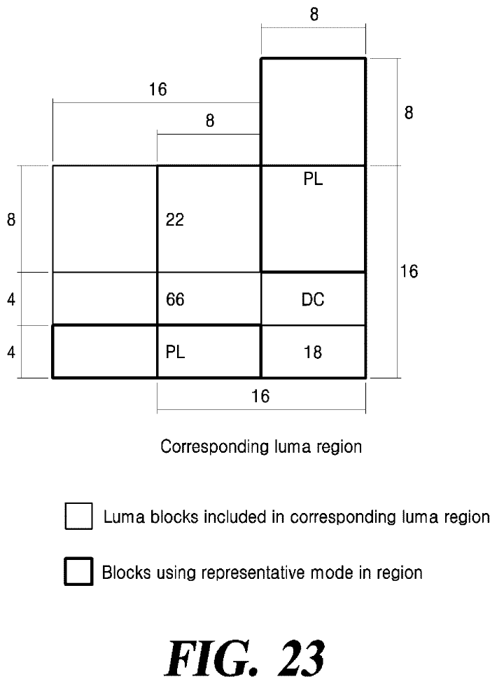

When the set representative mode is a directional mode, this implementation assumes that an intensity histogram is generated for the directional modes according to the first method of Implementation 1-2, as shown in the example of FIG. 24. The video decoding device may set weights by using the intensities of the representative modes from the intensity histogram. The following description of setting weights by using the intensity histogram assumes the representative mode M to be mode 19.

As an example, the weight may be set to a ratio of the intensity of the representative mode to the total of the intensities in the intensity histogram, as shown in Equation 18.

$$1 - {w}_{CCLM} = \frac{{I}_{M}}{{\sum }_{k ∈ IPM} {I}_{k}} \qquad [ Equation 18 ]$$

Thus, in the intensity histogram illustrated by FIG. 24, the weight of the representative mode is set to 25/95.

As another example, the weight may be set to be the ratio of the intensity of the representative mode to the sum of the n (n=2,3,4, . . . ) top intensities in the intensity histogram, as shown in Equation 19.

$$1 - {w}_{CCLM} = \frac{{I}_{M}}{{\sum }_{k} {I}_{k}} , \qquad [ Equation 19 ]$$

$$top n modes with high intensity among k ∈ IPM$$

When n is 3, in the intensity histogram illustrated by FIG. 24, the weight of the representative mode is set to 25/65.

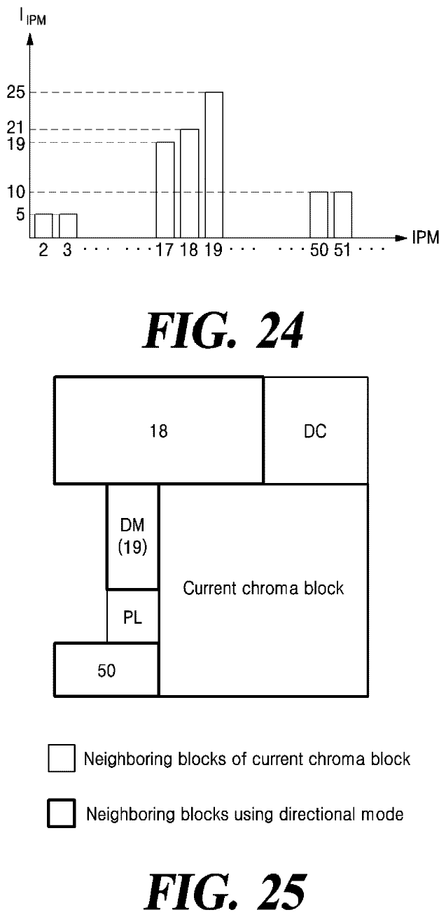

As yet another example, this implementation assumes that the current chroma block's neighboring blocks and the prediction modes are distributed as shown in the example of FIG. 25. Taking account of the representative mode and the directional modes among the prediction modes used by the current chroma block's neighboring blocks in the intensity histogram, this implementation may set as a weight the ratio of the intensity of the representative mode to the sum of the intensities of these directional modes, as shown in Equation 20.

$$1 - {w}_{CCLM} = \frac{{I}_{M}}{{\sum }_{k ∈ \{ 18 , 19 , 50 )} {I}_{k}} \qquad [ Equation 20 ]$$

Thus, in the intensity histogram illustrated by FIG. 24, the weight of the representative mode is set to 25/56.

In addition to these, weights may be set by using the intensities of the representative modes according to various other methods. When multiple additional predictors are weight-summed, after calculating the weights of the respective additional predictors in the same way, the video decoding device may set the value of 1 minus the sum of the weights of the additional predictors as the weight of the first predictor.

As a second method, the video decoding device may calculate the distortion of each prediction mode based on the information of neighboring pixels of the current chroma block, and may use the proportion of the distortions of the representative modes among the total distortion values to set the weight of the second predictor. For this purpose, the video decoding device may borrow the method used to derive the prediction mode in the TIMD technique. This implementation is very similar in behavior to the second method of Implementation 1-2. Upon calculating the distortion values D of the prediction mode candidates according to the second method of Implementations 1-2, the video decoding device replaces the value calculated according to Equation 21 or Equation 22 for each prediction mode candidate with the intensity value used in the first method of Implementations 1-2.

$${I}_{k} = \frac{1}{{D}_{k}} , k ∈ prediction mode candidates \qquad [ Equation 21 ]$$

$${I}_{k} = \frac{{\sum }_{l ∈ prediction mode candidates} {D}_{l}}{{D}_{k}} , k ∈ prediction mode candidates \qquad [ Equation 22 ]$$

The video decoding device may then generate an intensity histogram in the same manner as the first method of the present implementation, and may use the intensity histogram to set weights. Since the greater the intensity of each prediction mode, the more suitable it is as a representative mode, and conversely, the smaller the distortion of the prediction mode, the more suitable it is as a representative mode, the intensity and distortion have an inverse relationship. Therefore, in addition to Equation 21 and Equation 22, various other methods may be used to replace distortion with intensity. In addition to replacing distortion with intensity, various methods may be used to calculate the proportion of prediction mode candidates' distortion values that are attributable to the distortion of the representative mode and to set the weights by using this proportion.

To set the weights from the values of neighboring pixels of the current chroma block, various methods may be used in addition to the two examples described above.

### <Implementation 2-5> Using Reconstructed Information in and Around the Corresponding Luma Region

In this embodiment, the video decoding device sets the weight of the second predictor by using reconstructed information in and around the luma region, corresponding to the current chroma block, referred to as the ‘corresponding luma region’ hereinafter, i.e., information such as value/position/number of pixels in and neighboring the corresponding luma region. The reconstructed information in and around the corresponding luma region may include the corresponding luma region's internal block's and its neighboring blocks' width/height/area/aspect ratio/prediction mode/position/number, or the like, but the method of utilizing them depends on Implementation 2-3. Therefore, this implementation primarily describes a method based on the information in the corresponding luma region and information such as the value/position/number of the neighboring pixels. However, since this implementation uses only the reconstructed information in and around the corresponding luma region, this implementation may not infer a prediction mode (i.e., CCLM mode) that generates a chroma predictor by using the information of the corresponding luma region. As described above, the region containing the pixels within and neighboring the corresponding luma region is referred to as the luma pixel region.

The video decoding device may use one of the following methods to derive weights by using the reconstructed information within and around the corresponding luma region.

In the first method, the video decoding device may an edge detection filter to calculate the prediction modes and intensities derived from the values of pixels within and neighboring the corresponding luma region, and may set as the weight of the second predictor the proportion of the intensities of the representative modes among the total intensities. For this purpose, the video decoding device may borrow the method used by the DIMD technique to derive the prediction mode. This implementation is very similar in behavior to the first method of Implementations 1-3.

If the set representative mode is a directional mode, this implementation assumes that an intensity histogram has been generated for the directional modes according to the first method of Implementations 1-3, as shown in the example of FIG. 24. The video decoding device may set weights by using the intensities of the representative modes from the intensity histogram. Then, as in the first method of Implementations 2-4, the video decoding device may set the weights by using the intensities.

As a second method, the video decoding device may calculate the distortion of each prediction mode based on information of pixels within and neighboring the corresponding luma region, and may use the proportion of the distortions of the representative modes among the total distortion values when setting the weight of the second predictor. For this purpose, the video decoding device may borrow the method in the TIMD technique used to derive the prediction mode. This implementation is very similar in behavior to the second method of Implementations 1-3. The video decoding device may calculate the distortion values D of the prediction mode candidates according to the second method of Implementations 1-3, and then may set the weights by using the same substituted intensities as the second method of Implementations 2-4.

In addition to the two examples described above, various methods may be used to set weights from values of pixels within and neighboring the corresponding luma region.

### <Implementation 3> Method of Signaling the Prediction Mode and Weight of the Second Predictor

In this implementation, the video decoding device does not infer information for intra prediction of the current chroma block, but uses the information signaled by the video encoding device. For example, the second predictor's prediction mode-related information, the weight summing-related information, and the like are transmitted from the video encoding device to the video decoding device. Additionally, the application or non-application of embodiments of the present disclosure may be signaled from the video encoding device to the video decoding device.

### <Implementation 3-1> Method of Signaling Prediction Mode-Related Information

In this implementation, information related to a prediction mode, for generating a second predictor, referred to as a ‘representative mode’ hereinafter is directly signaled from the video encoding device to the video decoding device. The relevant information includes the number of representative modes, a representative mode-deriving method, a representative mode index, and the like.

As a first method, the number of representative modes may be signaled as follows. For example, the number of representative modes may be preset at a level higher than the CU, such as SPS (Sequence Parameter Set), VPS (Video Parameter Set), PPS (Picture Parameter Set), SH (Slice Header), CTU (Coding Tree Unit), or the like. For example, as shown in Table 3, the number of representative modes, sps_ccip_extra_mode_num may be predefined on SPS.

TABLE 3
[SPS Syntax Level]

sps_ccip_extra_mode_num

Here, ccip in the variable name is an abbreviation for cross ‘CCLM Intra Prediction’. Hereinafter, ccip is inserted in the variable name of the signal associated with embodiments of the present disclosure.

The video encoding device encodes a preset number of representative modes and signals them to the video decoding device by including the same in a bitstream. The video decoding device parses the sps_ccip_extra_mode_num in the bitstream. Then, the value of the sps_ccip_extra_mode_num determines the number of representative modes to be derived when the prediction is performed.

As another example, the number of representative modes may be signaled each time a prediction is performed at the CU level. The process of parsing the intra-prediction modes in the chroma channel described in Table 2 may be modified as in the examples of Table 4 through Table 6. According to Table 4 or Table 5, by further parsing ccip_extra_mode_num according to the type of prediction mode, the number of representative modes required for each block prediction may be signaled.

TABLE 4
[CU Level]

```
if( CclmEnabled )
  cclm_mode_flag
if( cclm_mode_flag ){
  cclm_mode_idx
  ccip_extra_mode_num
}else
  intra_chroma_pred_mode
```

TABLE 5
[CU Level]

```
if( CclmEnabled )
  cclm_mode_flag
if( cclm_mode_flag )
  cclm_mode_idx
else{
  ccip_extra_mode_num
  intra_chroma_pred_mode
}
```

Alternatively, ccip_extra_mode_num may be additionally parsed regardless of the prediction mode, as shown in Table 6.

TABLE 6
[CU Level]

```
ccip_extra_mode_num
if( CclmEnabled )
  cclm_mode_flag
if( cclm_mode_flag )
  cclm_mode_idx
else
  intra_chroma_pred_mode
```

In a second method, the representative mode-deriving methods may be signaled as follows. First, the representative mode-deriving methods presented in Implementation 1 may be classified by indices, as illustrated in Table 7.

TABLE 7

| | Representative mode |
|---|---|
| (sps_)ccip_mode_infer_idx | deriving method |
| 0 | Implementation 1-1 |
| 1 | Implementation 1-2 |
| 2 | Implementation 1-3 |
| . | . |
| . | . |
| . | . |

In one example, the representative mode-deriving method may be predefined at a higher level than the CU, such as SPS/VPS/PPS/SH/CTU, or the like. For example, as shown in Table 8, the index sps_ccip_mode_infer_idx of the representative mode-deriving method may be predefined on the SPS.

TABLE 8
[SPS Syntax Level]

sps_ccip_mode_infer_idx

The video encoding device encodes the index of the predefined representative mode-deriving method and includes it in a bitstream and signals it to the video decoding device. The video decoding device parses the sps_ccip_mode_infer_idx in the bitstream. Then, the value of sps_ccip_mode_infer_idx determines a representative mode-deriving method to be used when the prediction is performed.

As another example, the representative mode-deriving method may be signaled each time a prediction is performed at the CU level. In the process of parsing the intra-prediction mode of the chroma channel, the representative mode-deriving method required for each block prediction may be signaled by further parsing ccip_mode_infer_idx according to the type of prediction mode, as shown in Table 9 or Table 10.

TABLE 9
[CU Level]

```
if( CclmEnabled )
  cclm_mode_flag
if( cclm_mode_flag ){
  cclm_mode_idx
  ccip_mode_infer_idx
}else
  intra_chroma_pred_mode
```

TABLE 10
[CU Level]

```
if( CclmEnabled )
  cclm_mode_flag
if( cclm_mode_flag )
  cclm_mode_idx
else{
  ccip_mode_infer_idx
  intra_chroma_pred_mode
}
```

Alternatively, ccip_mode_infer_idx may be further parsed regardless of the prediction mode, as shown in Table 11.

TABLE 11
[CU Level]

```
ccip_mode_infer_idx
if( CclmEnabled )
  cclm_mode_flag
if( cclm_mode_flag )
  cclm_mode_idx
else
  intra_chroma_pred_mode
```

As a third method, the representative mode index may be signaled as follows. In one example, the representative mode index may be preset at a level higher than the CU, such as SPS/VPS/PPS/SH/CTU, or the like. For example, as shown in Table 12, the representative mode index sps_ccip_extra_mode_idx may be predefined on the SPS.

TABLE 12
[SPS Syntax Level]

sps_ccip_extra_mode_idx

The video encoding device encodes the predefined representative mode index and includes it in the bitstream and signals it to the video decoding device. The video decoding device parses the sps_ccip_extra_mode_idx in the bitstream. The value of the sps_ccip_extra_mode_idx then determines a representative mode to use when the prediction is performed.

As another example, the representative mode index may be signaled each time a prediction is performed at the CU level. During the parsing of the intra-prediction mode of the chroma channel, the representative mode index required for each block prediction may be signaled by further parsing the ccip_extra_mode_idx according to the type of prediction mode, as shown in Table 13 or Table 14.

TABLE 13
[CU Level]

```
if( CclmEnabled )
  cclm_mode_flag
if( cclm_mode_flag ){
  cclm_mode_idx
  ccip_extra_mode_idx
}else
  intra_chroma_pred_mode
```

TABLE 14
[CU Level]

```
if( CclmEnabled )
  cclm_mode_flag
if( cclm_mode_flag )
  cclm_mode_idx
else{
  ccip_extra_mode_idx
  intra_chroma_pred_mode
}
```

Alternatively, ccip_extra_mode_idx may additionally be parsed regardless of the prediction mode, as shown in Table 15.

TABLE 15
[CU Level]

```
ccip_extra_mode_idx
if( CclmEnabled )
  cclm_mode_flag
if( cclm_mode_flag )
  cclm_mode_idx
else
  intra_chroma_pred_mode
```

In this case, ccip_extra_mode_idx indicates one index when the number of representative modes is one. Further, ccip_extra_mode_idx may be a list of multiple representative mode indices when multiple representative modes are used.

In an example of the present implementation, a representative mode-deriving method may be signaled when the representative mode number or count information is signaled. Alternatively, a preset number of representative modes may be used without signaling the representative mode count information, and the indices of the representative modes may be signaled in place of the information on the representative mode-deriving method. By selecting various combinations of relevant information to be signaled and relevant information not to be signaled, various prediction methods may be generated.

### <Implementation 3-2> Method of Signaling Weight Summing-Related Information

In this implementation, the weight summing-related information is signaled from the video encoding device to the video decoding device. The weight summing-related information includes a weight summing method, weights of the weighted summation, an importance weight, and the like. Here, the importance weight is used as a multiplier value in the neighboring pixel correlation and luma pixel correlation calculation process in Implementation 2-2 and Implementation 2-3.

In the first method, the weight summing method may be signaled as follows. First, the weight-summing methods presented in Implementation 2 may be classified by indices, as illustrated in Table 16.

TABLE 16

| (sps_)ccip_weight_calc_mode_idx | Weight summing method |
|---|---|
| 0 | Implementation 2-1 |
| 1 | Implementation 2-2 |
| 2 | Implementation 2-3 |
| 3 | Implementation 2-4 |
| . | . |
| . | . |
| . | . |

In one example, a weight summing method may be preset at a higher level than the CU, such as SPS/VPS/PPS/SH/CTU, or the like. For example, as shown in Table 17, the index sps_ccip_weight_calc_mode_idx of the weight summing method may be predefined on the SPS.

TABLE 17
[SPS Syntax Level]

sps_ccip_weight_calc_mode_idx

The video encoding device encodes the index of the predefined weight summing method and includes it in the bitstream and signals it to the video decoding device. The video decoding device parses the sps_ccip_weight_calc_mode_idx in the bitstream. Then, based on the value of sps_ccip_weight_calc_mode_idx, the video decoding device determines a weight-summing method to use when the prediction is performed.

As another example, the weight summing method may be signaled each time a prediction is performed at the CU level. During the intra-prediction mode parsing of the chroma channel, the weight summing method to be used for each block prediction may be signaled by further parsing ccip_weight_calc_mode_idx according to the type of prediction mode, as shown in Table 18 or Table 19.

TABLE 18
[CU Level]

```
if( CclmEnabled )
  cclm_mode_flag
if( cclm_mode_flag ){
  cclm_mode_idx
  ccip_weight_calc_mode_idx
}else
  intra_chroma_pred_mode
```

TABLE 19
[CU Level]

```
if( CclmEnabled )
  cclm_mode_flag
if( cclm_mode_flag )
  cclm_mode_idx
else{
  ccip_weight_calc_mode_idx
  intra_chroma_pred_mode
}
```

Alternatively, ccip_weight_calc_mode_idx may be further parsed regardless of the type of prediction mode, as shown in Table 20.

TABLE 20
[CU Level]

```
ccip_weight_calc_mode_idx
if( CclmEnabled )
  cclm_mode_flag
if( cclm_mode_flag )
  cclm_mode_idx
else
  intra_chroma_pred_mode
```

As a second method, the weights of the weighted summation may be signaled as follows. For example, the weights of the weighted summation may be preset at a level higher than the CU, such as SPS/VPS/PPS/SH/CTU, or the like. For example, as shown in Table 21, the weights of the weighted summation, sps_ccip_pred_weight may be predefined on the SPS.

TABLE 21
[SPS Syntax Level]

sps_ccip_pred_weight

The video encoding device encodes the predefined weights of the weighted summation and includes them in the bitstream and signals them to the video decoding device. The video decoding device parses the sps_ccip_pred_weight in the bitstream. Then, based on the value of the sps_ccip_pred_weight, the video decoding device determines a weight-summing method to use when performing the prediction.

As another example, the weights of the weighted summation may be signaled each time a prediction is performed at the CU level. During the parsing of the intra-prediction mode of the chroma channel, the weights of the weighted summation required for each block prediction may be signaled by further parsing the ccip_pred_weight according to the type of prediction mode, as shown in Table 22 or Table 23.

TABLE 22
[CU Level]

```
if( CclmEnabled )
  cclm_mode_flag
if( cclm_mode_flag ){
  cclm_mode_idx
  ccip_pred_weight
}else
  intra_chroma_pred_mode
```

TABLE 23
[CU Level]

```
if( CclmEnabled )
  cclm_mode_flag
if( cclm_mode_flag )
  cclm_mode_idx
else{
  ccip_pred_weight
  intra_chroma_pred_mode
}
```

Alternatively, ccip_pred_weight may additionally be parsed regardless of the prediction mode, as shown in Table 24.

TABLE 24
[CU Level]

```
ccip_pred_weight
if( CclmEnabled )
  cclm_mode_flag
if( cclm_mode_flag )
  cclm_mode_idx
else
  intra_chroma_pred_mode
```

In this case, ccip_pred_weight represents one weight for the first predictor (or second predictor) when the number of representative modes is one. In addition, ccip_pred_weight, i.e., the number of representative modes in the list may increase if multiple representative modes are used.

In addition, in Implementation 2-2 and Implementation 2-3, the importance weight used as the multiplier during the neighboring pixel correlation and luma pixel correlation calculations may be signaled in the same manner as the weights of the weighted summation. In this case, the importance weight may be signaled by changing ccip_pred_weight to ccip_relativity_importance in Table 21 through Table 24.

### <Implementation 3-3> Method of Signaling the Application or Non-Application of the Present Disclosure

The applicability of the present disclosure may be signaled as follows. In one example, a flag may be preset at a level higher than the CU, such as SPS/VPS/PPS/SH/CTU, to indicate the use of an enhanced predictor, i.e., predictor pred_{C} exemplified in Equation 3 and Equation 4, based on a combination of implementations of the present disclosure over an existing predictor. For example, as shown in Table 25, the flag, sps_ccip_mode_flag may be predefined to indicate the use of the enhanced predictor on SPS.

TABLE 25
[SPS Syntax Level]

sps_ccip_mode_flag

The video encoding device encodes a flag indicating the use of the predefined enhanced predictor and signals it to the video decoding device by including it in the bitstream. The video decoding device parses the sps_ccip_mode_flag in the bitstream. The video decoding device may not apply the present disclosure when sps_ccip_mode_flag=0, and may use the enhanced CCLM mode to generate the predictor when sps_ccip_mode_flag=1.

As an example of the present disclosure, Implementation 3-1 and Implementation 3-2 may be combined. For example, once the applicability of the present disclosure is signaled and its application is determined, the methods of Implementation 3-1 and Implementation 3-2 may be applied.

As another example, the applicability of the present disclosure may be signaled at a lower level. For example, at the CU level, the ccip_mode_flag may be used to determine the applicability of the present disclosure. The video decoding device may not apply the present disclosure when the ccip_mode_flag is 0, and may weight sum the first predictor and the second predictor when the ccip_mode_flag is 1 to generate a final predictor.

The video decoding device may parse the ccip_mode_flag as shown in Table 26 and Table 27, depending on the type of prediction mode.

TABLE 26
[CU Level]

```
if( CclmEnabled )
  cclm_mode_flag
if( cclm_mode_flag ){
  ccip_mode_flag
  cclm_mode_idx
}else
  intra_chroma_pred_mode
```

TABLE 27
[CU Level]

```
if( CclmEnabled )
  cclm_mode_flag
if( cclm_mode_flag )
  cclm_mode_idx
else{
  ccip_mode_flag
  intra_chroma_pred_mode
}
```

Alternatively, the ccip_mode_flag may be parsed regardless of the prediction mode, as shown in Table 28.

TABLE 28
[CU Level]

```
ccip_mode_flag
if( CclmEnabled )
  cclm_mode_flag
if( cclm_mode_flag )
  cclm_mode_idx
else
  intra_chroma_pred_mode
```

On one hand, if the prediction mode is one of the CCLM modes and the ccip_mode_flag is 1, the representative mode according to the present disclosure may be the same-channel prediction mode that generates a predictor by using the \textcircled{2} information of the same channel. On the other hand, if the prediction mode is one of the prediction modes utilizing the same-channel information and the ccip_mode_flag is 1, the representative mode according to the present disclosure may be the cross-component prediction mode that generates a predictor by using the \textcircled{1}) information of the corresponding luma region.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
542: intra predictor
802: input unit
804: first predictor generator
806: second predictor generator
808: weight summer

1. A method of intra predicting a current chroma block by a video decoding device, the method comprising:
decoding a cross-component prediction mode for making a cross-component prediction for the current chroma block, the cross-component prediction predicting the current chroma block by using pixels of a corresponding luma region with respect to the current chroma block and the corresponding luma region;
generating a first predictor of the current chroma block by performing the cross-component prediction based on the cross-component prediction mode;
inferring a representative mode from reconstructed information on a neighboring chroma pixel region that comprises pixels neighboring the current chroma block, the reconstructed information containing values of pixels in the neighboring chroma pixel region, positions of the pixels, and a number of the pixels;
generating a second predictor of the current chroma block by performing an intra prediction that uses neighboring pixels of the current chroma block based on the representative mode;
deriving weights for the first predictor and the second predictor; and
generating an intra predictor of the current chroma block by weight summing the first predictor and the second predictor by using the weights.

2. The method of claim 1, wherein inferring the representative mode comprises:
setting the neighboring chroma pixel region;
generating directional modes and intensities corresponding to the directional modes by applying an edge detection filter to the neighboring chroma pixel region, and generating an intensity histogram by using the intensities; and
setting the representative mode with a directional mode having a largest intensity value in the intensity histogram.

3. The method of claim 2, wherein generating the intensity histogram comprises:
applying the edge detection filter to respective pixels in the neighboring chroma pixel region to calculate slopes and magnitudes of the slopes, then substituting each of the slopes with a directional mode corresponding to each slope, deriving an intensity of the directional mode by using a magnitude of each slope, and accumulating intensities of directional modes to generate the intensity histogram.

4. The method of claim 2, wherein inferring the representative mode comprises, when inferring the representative mode in a plural number:
inferring a plurality of representative modes in order of magnitude of the intensities in the intensity histogram.

5. The method of claim 1, wherein inferring the representative mode comprises, when inferring the representative mode in a plural number:
partitioning the neighboring chroma pixel region into a top region and a left region;
generating directional modes and intensities corresponding to the directional modes by applying an edge detection filter to the top region and left region, and generating, by using the intensities, intensity histograms of the top region and left region; and
setting, as a plurality of representative modes, a directional mode having a largest intensity value in the intensity histogram of the top region and a directional mode having a largest intensity value in the intensity histogram of the left region.

6. The method of claim 2, wherein inferring the representative mode comprises:
setting the representative mode from the directional modes by using a preset priority in response to directional modes being present with the intensities that are equal.

7. The method of claim 1, wherein inferring the representative mode comprises:
setting the neighboring chroma pixel region;
generating a distortion of each prediction mode of all prediction modes by using left and top neighboring pixels of the neighboring chroma pixel region, each prediction mode generating a predictor of the neighboring chroma pixel region based on neighboring pixels of the neighboring chroma pixel region; and
setting a prediction mode having a smallest distortion among all prediction modes as the representative mode.

8. The method of claim 7, wherein generating the distortion comprises:
generating a predictor of each prediction mode by using the left and top neighboring pixels of the neighboring chroma pixel region, and then calculating a similarity difference between the predictor and reconstructed pixel values in the neighboring chroma pixel region to generate the distortion.

9. The method of claim 2, wherein deriving the weights comprises:
setting as the weight of the second predictor a ratio of an intensity of the representative mode to a sum of the intensities or some upper part of the intensities.

10. The method of claim 2, wherein deriving the weights comprises:
with respect to the representative mode and directional modes among prediction modes that are used in the intensity histogram by neighboring blocks of the current chroma block, setting as the weight of the second predictor a ratio of an intensity of the representative mode to a sum of the intensities of the directional modes.

11. The method of claim 7, wherein deriving the weights comprises:
converting the distortion of each prediction mode into an intensity based on a relationship of inverse proportionality between a distortion and the intensity.

12. The method of claim 11, wherein deriving the weights comprises:
setting as the weight of the second predictor a ratio of an intensity of the representative mode to a sum of the intensities of all prediction modes or some upper part of the intensities of all prediction modes.

13. A method of intra predicting a current chroma block by a video encoding device, the method comprising:
determining a cross-component prediction mode for making a cross-component prediction for the current chroma block, the cross-component prediction predicting the current chroma block by using pixels of a corresponding luma region with respect to the current chroma block and the corresponding luma region;
generating a first predictor of the current chroma block by performing the cross-component prediction based on the cross-component prediction mode;
inferring a representative mode from reconstructed information on a neighboring chroma pixel region that comprises pixels neighboring the current chroma block, the reconstructed information containing values of pixels in the neighboring chroma pixel region, positions of the pixels, and a number of the pixels;
generating a second predictor of the current chroma block by performing an intra prediction that uses neighboring pixels of the current chroma block based on the representative mode;
deriving weights for the first predictor and the second predictor; and
generating an intra predictor of the current chroma block by weight summing the first predictor and the second predictor by using the weights.

14. The method of claim 13, further comprising:
encoding the cross-component prediction mode.

15. A computer-readable recording medium storing a bitstream generated by a video encoding method, the video encoding method comprises:
determining a cross-component prediction mode for making a cross-component prediction for a current chroma block, the cross-component prediction predicting the current chroma block by using pixels of a corresponding luma region for the current chroma block and the corresponding luma region;
generating a first predictor of the current chroma block by performing the cross-component prediction based on the cross-component prediction mode;
inferring a representative mode from reconstructed information on a neighboring chroma pixel region that comprises pixels neighboring the current chroma block, the reconstructed information containing values of pixels in the neighboring chroma pixel region, positions of the pixels, and a number of the pixels;
generating a second predictor of the current chroma block by performing an intra prediction that uses neighboring pixels of the current chroma block based on the representative mode;
deriving weights for the first predictor and the second predictor; and
generating an intra predictor of the current chroma block by weight summing the first predictor and the second predictor by using the weights.
